(19) United States
(12) Patent Application Publication
(10) Pub. No.: US 2023/0286675 A1
(43) Pub. Date: Sep. 14, 2023

(54) Autonomous Satellite Navigation

(71) Applicant: The Government of the United States of America, as represented by the Secretary of the Navy, Arlington, VA (US)

(72) Inventors: Evan M. Ward, Alexandria, VA (US); Bryan C. Brown, Silver Spring, MD (US); David F. Chicka, Vienna, VA (US); Nathaniel K. Ng, Washington, DC (US)

(21) Appl. No.: 18/118,720

(22) Filed: Mar. 7, 2023

Related U.S. Application Data
(60) Provisional application No. 63/317,151, filed on Mar. 7, 2022.

(51) Int. Cl. B64G 1/24; B64G 1/36; G06T 7/11

(52) U.S. Cl. CPC B64G 1/244; B64G 1/361; B64G 1/365; G06T 7/11; B64G 2001/247

(57) ABSTRACT

Systems and methods are provided for high fidelity long-duration autonomous spacecraft navigation relative to a planet's surface and measuring the dynamics of the planet. For a planet like Earth, embodiments of the present disclosure can be used to estimate the unpredictable components of Earth's orientation with respect to the inertial frame. Embodiments of the present disclosure further enable autonomous landmark navigation by providing systems and methods for satellites to autonomously recognize landmarks, using, for example, multiple computer vision approaches to recognize multiple types of landmarks.

### CROSS REFERENCE TO RELATED APPLICATIONS

This application claims the benefit of U.S. Provisional Patent Application No. 63/317,151, filed on Mar. 7, 2022, which is incorporated by reference herein in its entirety.

### FEDERALLY SPONSORED RESEARCH AND DEVELOPMENT

The United States Government has ownership rights in this invention. Licensing inquiries may be directed to Office of Technology Transfer at US Naval Research Laboratory, Code 1004, Washington, DC 20375, USA; +1.202.767.7230; techtran@nrl.navy.mil, referencing Navy Case Number 210998-US2.

### FIELD OF THE DISCLOSURE

This disclosure relates to device navigation, including spacecraft navigation.

### BACKGROUND

A spacecraft can be navigated via sightings to landmarks, sometimes known as optical navigation, using techniques similar to those used by mariners and aviators. Navigation using landmarks allows for spacecraft autonomy from ground command, control, and tracking stations.

A direction measurement to a known landmark constrains the vehicle to lie on a line. Repeated direction measurements to unknown landmarks during a pass can also be used to update the spacecraft's position and velocity. Using known landmarks provides better sensitivity for precise orbit determination and better tie to the Earth fixed frame. On the other hand, using unknown landmarks does not require landmarks to be identified in various lighting conditions and it does not require a map or database of landmarks as it can use any visually distinctive feature.

Autonomous landmark navigation is especially important to deep space missions that need to navigate near another body, such as for rendezvous with an asteroid. Conventional techniques require assumptions that the central body's orientation is perfectly modeled, that corrections are obtains from an external source, or that the spacecraft clock used to time tag the measurements has no errors. High-accuracy long duration autonomous flight requires accounting for errors in the orientation of the central body and measurement of the independent variable: time.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1 is a block diagram of an exemplary navigational device, such as a spacecraft, in accordance with an embodiment of the present disclosure;

FIG. 2 is a flowchart showing exemplary steps that can be used to navigate via landmarks in accordance with an embodiment of the present disclosure;

FIG. 3 is a flowchart of an exemplary method for reducing observations in accordance with an embodiment of the present disclosure;

FIG. 4 is a flowchart of an exemplary method for determining spacecraft state and Earth orientation from landmark measurements in accordance with an embodiment of the present disclosure;

FIG. 5 is a flowchart of an exemplary method for detecting landmarks in satellite images using image segmentation in accordance with an embodiment of the present disclosure;

FIG. 6 is a flowchart of an exemplary method for detecting landmarks in satellite images using image segmentation in accordance with an embodiment of the present disclosure; and

FIG. 7 is a block diagram of an exemplary spacecraft device in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to understand that such description(s) can affect such feature, structure, or characteristic in connection with other embodiments whether or not explicitly described.

### 1. OVERVIEW

Embodiments of the present disclosure enable high fidelity long-duration autonomous spacecraft navigation relative to a planet's surface and measuring the dynamics of the planet. For a planet like Earth, embodiments of the present disclosure can be used to estimate the unpredictable components of Earth's orientation with respect to the inertial frame. Embodiments of the present disclosure further enable autonomous landmark navigation by providing systems and methods for satellites to autonomously recognize landmarks, using, for example, multiple computer vision approaches to recognize multiple types of landmarks

Embodiments of the present disclosure improve reliability and enable new missions for military and civil space. For spacecraft orbiting Earth, embodiments of the present disclosure can provide systems and methods for long-term autonomous navigation without a requirement for global positioning satellite (GPS) or regular ground contacts for ephemeris updates. For spacecraft orbiting other planets, embodiments of the present disclosure can enable a way to “bootstrap” navigation in an environment without GPS, with limited contacts, and with incomplete or even no prior knowledge of available landmarks. Navigation using landmarks allows for spacecraft autonomy from ground command, control, and tracking stations. This enables navigation to be immune to disruptions of the ground infrastructure, whether caused by equipment malfunctions, natural disasters, jamming, or sabotage. Landmarks can include any object, useful for navigation, which can be observed by a spacecraft. Autonomous landmark navigation can be especially important for deep space missions that need to navigate near another body, such as for rendezvous with an asteroid.

Convolutional neural networks can be used to classify objects in images, and segmentation routines such as U-net can be used to label each pixel in an image according to a “class.” Algorithms, such as the Scale Invariant Feature Transform (SIFT) algorithm can provide key point detection based on difference of Gaussians. Speeded Up Robust Features (SURF) is another algorithm that can be used for key point detection and matching. Features form Accelerated Segment Test (FAST) is an algorithm that can perform corner detection, while Rotated Binary Robust Independent Elementary Features (BRIEF) is a feature detector. Oriented FAST & BRIEF (ORB) combines FAST and BRIEF and can be used to perform key point detection and matching in a manner similar to SIFT and SURF, but faster.

Conventional navigation techniques have drawbacks, including requiring assumptions that the central body's orientation is perfectly modeled, that corrections are obtained from an external source, or that the spacecraft clock used to time tag the measurements has no errors. These assumptions can be especially problematic for high-accuracy long duration autonomous flight, which can require accounting for errors in the orientation of the central body and measurement of the independent variable time. Embodiments of the present disclosure can use Earth landmarks in changing seasons and weather and can include explicit estimation of Earth's orientation in space. Embodiments of the present disclosure provide systems and methods that can adapt and train for specific landmarks, can use machine learning techniques to identify specific airports, and can associate individual pixels over large perspective changes.

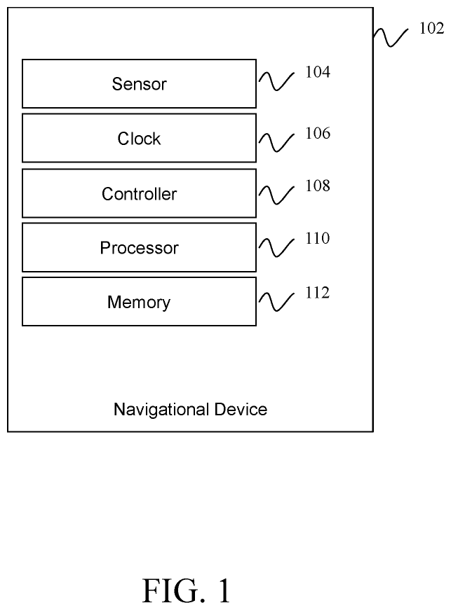

FIG. 1 is a block diagram of an exemplary navigational device 102, such as a spacecraft, in accordance with an embodiment of the present disclosure. In an embodiment, navigational device 102 is a satellite. In FIG. 1, navigational device 102 includes a sensor 104, a clock 106, a controller 108, a processor 110, and a memory 112. Embodiments of the present disclosure can be implemented using hardware, software, and/or a combination of hardware and software. Embodiments of the present disclosure can be implemented using one or more devices. In an embodiment, components of navigational device 102 are implemented as a special purpose device. For example, in an embodiment, navigational device 102 is a spacecraft, and components of navigational device 102 are implemented as on-board components of the spacecraft.

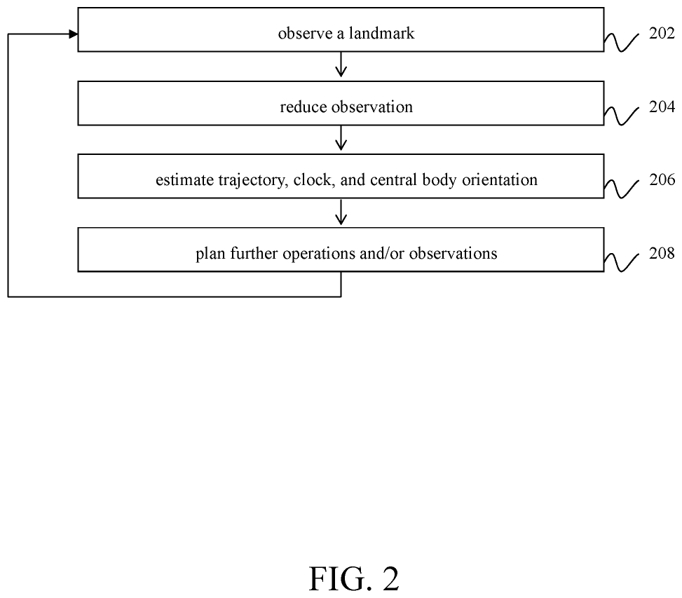

FIG. 2 is a flowchart showing exemplary steps that can be used to navigate via landmarks in accordance with an embodiment of the present disclosure. In step 202, navigational device 102 can use one or more sensors, such as sensor 104, to observe one or more landmarks. For example, sensor 104 can use visible, radio, and/or other phenomena that can remotely sense the landmark. In an embodiment, a landmark is any feature that can be distinguished by sensor 104. For example, a landmark can be a mountain peak, an asteroid, or another spacecraft, such as a satellite. The trajectory of the landmark may be known a priori, or not. The landmark may be moving or stationary. In an embodiment, the observations can be time-tagged by clock 106. In an embodiment, the information sensed by sensor 104 can be stored in memory 112 and can be accessed by controller 108 and/or processor 110.

In step 204, the observations can be reduced. For example, in an embodiment, the observations can be reduced (e.g., using controller 108 and/or processor 110) such that each observation of a landmark includes the direction from navigational device 102 to the landmark in the inertial frame. This can be accomplished, for example, by using a machine learning model to locate a mountain peak in an image and a star tracker to determine the spacecraft's orientation in the inertial frame. Optionally, autonomous measurements of range to the landmark may be included (e.g., radio detection and ranging (RADAR) or light detection and ranging (LIDAR)).

In step 206, the observations can be combined (e.g., using controller 108 and/or processor 110) to estimate the trajectory, clock, and central body orientation of navigational device 102 (e.g., in an embodiment, using weighted lease squares or an extended Kalman filter). In step 208, the estimate from step 206 can be used (e.g., using controller 108 and/or processor 110) to conduct operations and to plan further landmark observations. The process can then optionally return to step 202.

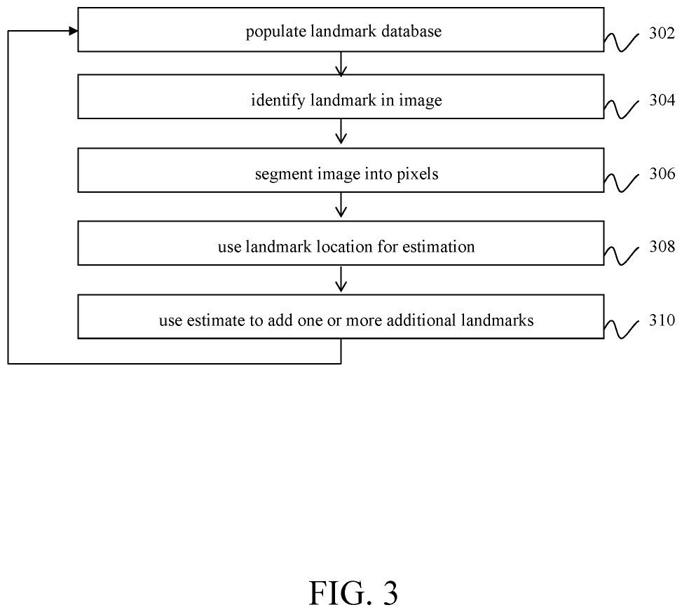

FIG. 3 is a flowchart of an exemplary method for reducing observations in accordance with an embodiment of the present disclosure. For example, in an embodiment, FIG. 3 is a flowchart showing more detailed steps that can be used to accomplish step 204 in FIG. 2. In step 302, an on-board landmark database is populated. For example, in an embodiment, a database on-board navigational device 102 (e.g., stored in memory 112) can include landmarks described by their geometric shapes (e.g., points, lines, polygons, etc.) and their coordinates in the central body fixed reference frame. For example, this database can include roads, rives, coastlines, etc.

In step 304, the landmark can be identified (e.g., using controller 108 and/or processor 110) in an image using, for example, an object detection algorithm, such as a convolutional neural net (CNN). In an embodiment, the algorithm can be used to detect landmarks and label an image chip as a particular landmark. In step 306, the image can be segmented into pixels identifying them as part of or not part of the landmark. For example, in an embodiment, an image segmentation algorithm, such as a U-Net, can be used to segment the individual pixels of the image as those part and not part of the landmark (e.g., road or not road).

In step 308, the landmark location is used (e.g., using controller 108 and/or processor 110) for estimation. For example, in an embodiment, through a series of affine transformations, the image segmentation can be matched against the landmark database to associate known central body fixed coordinates with particular locations in the image. In step 310, the estimate can be used (e.g., using controller 108 and/or processor 110) to add one or more additional landmarks. For example, in an embodiment, the association between image pixel locations and central body fixed coordinates can be used as input to step 206 in the method of FIG. 2. In an embodiment, the method can proceed back to step 302, and this method may be repeated (e.g., using the output of step 206 of the method of FIG. 2) to add additional landmarks to the database autonomously.

As discussed above, embodiments of the present disclosure provide systems and methods for reducing observations and estimating navigational data in a more efficient and comprehensive way than that of conventional techniques. For example, to reduce observations, embodiments of the present disclosure can convert an image to landmark directions by combining computer vision and machine learning algorithms in parallel. In an embodiment, this includes training a convolutional neural network to find the landmarks of interest and passing the result along to an image segmentation model that can extract navigational information on a pixel-based level. To estimate navigational data, embodiments of the present disclosure can calculate the trajectory, clock, and central body orientation (e.g., estimating Earth Orientation Parameters (EOP)) of navigational device 102 from landmark observations.

Embodiments of the present disclosure provide several advantages, including autonomy from large ground station networks maintained by the International Earth Rotation Service (IERS), US Naval Observatory (USNO), and others to measure Earth's orientation in space. Conventional techniques required these Earth Orientation Parameters (EOP) to be uplinked to a spacecraft. Embodiments of the present disclosure enable a spacecraft to be able to determine EOP autonomously. Further, the measured EOP may be useful science data. For example, a deep space mission to a comet could estimate some physical parameters of its central body autonomously. As mentioned earlier, autonomy provides opportunities for increased resiliency, reliability, and capability while using fewer ground resources.

### 2. KEY POINTS FOR LANDMARK IDENTIFICATION

Exemplary systems and methods for landmark identification with respect to embodiments of the present disclosure will now be discussed in greater detail. The Oriented Features from Accelerated Segment Test (FAST) and Rotated Binary Robust Independent Elementar Features (BRIEF) (ORB) detector is an algorithm that computes features in images called key points that are used as references into a database to perform object recognition. This algorithm shares similarities with the Scale Invariant Feature Transform (SIFT) and will be used to facilitate the detection of Tiepoints on airport runways and the unique road networks nearby that service the detected airport.

In an embodiment, SIFT looks at features in an image that are invariant to rotation, translation, and local geometric distortions. The algorithm creates features from the image called key points, which is the result of a difference of Gaussians in scale-space. These key points can be used to create a database of feature vectors which allows it to match previously seen images to the one that is currently being presented to the system.

The SIFT algorithm has been successfully used for object recognition, robotic vision, gesture recognition, and 3D modeling and other computer vision related domains; however, SIFT has significant problems with repeating patterns (e.g., a Hawaiian shirt) as it finds key points everywhere that are similar, and it cannot accurately match them in the database. It also has problems with specular reflections. The ORB algorithm is two orders of magnitude faster that SIFT, enables near real-time matching of images, and uses FAST to find key points and BRIEF to describe the relationship between the key points for matching.

### 2.1 SIFT Key Point Localization

In an embodiment, for Scale Invariant Feature Transform (SIFT) to detect the key points, the first step is to perform a Gaussian convolution across the different scales in scale-space for the entire octave. The points of interest can given by calculating the Difference of Gaussians (DoG). The DoG D(x, y, σ) can given by:

D(x,y,σ)=L(x,y,kᵢσ)−L(x,y,kⱼσ) (1)

where L(x, y, kᵢ, σ) is the convolution of the original image I(x, y) with the Gaussian blur G(x, y, kσ) at scale kσ, i.e.:

L(x,y,kσ)=G(x,y,kσ)*I(x,y) (2)

Hence, in an embodiment, a DoG image between scales is the difference of Gaussian-blurred images at different scales kᵢσ and kⱼσ. These images are grouped by octaves, where an octave is a doubling of σ, and the value kᵢ is chosen to obtain a fixed number of convolved images per octave. Once these DoG images have been obtained, the key points can be calculated on a pixel-wise basis by comparing the 8 neighbor pixels across all scales. If this calculation is a minimum or a maximum, then it can be considered as a candidate key point. These candidate key points can be further refined through key point localization. In an embodiment, the first step is to perform an interpolation of nearby data to accurately determine its position. This interpolation is performed by using the quadratic Taylor series expansion of D(x, y, σ) with the candidate key point as the origin. This expansion is given by:

$$D ( x ) = D + \frac{δ {D}^{T}}{δ \vec{x}} \vec{x} + \frac{1}{2} {\vec{x}}^{T} \frac{{δ}^{2} D}{δ {\vec{x}}^{2}} \vec{x} \qquad ( 3 )$$

where D and its derivatives are evaluated at the candidate key point and \vec{x}=(x, y, σ)^{T} is the offset from the point. The location of the extremum, \hat{\vec{x}} can be determined by taking the derivative and setting it to zero. If the offset \hat{\vec{x}} is greater than 0.5 in any dimension, it indicates that the extremum lies closer to another key point. Note that SIFT uses several heuristics/rules of thumb that have been determined empirically for general scene matching (e.g., \hat{\vec{x}}≤0:5).

In an embodiment, the final steps for candidate key point localization are discarding low-contrast key points and the elimination of sharp edge responses (to make the final key points robust in dealing with small amounts of noise). To discard the low-contrast key points, the second-order Taylor expansion D(\vec{x}) can be computed at the offset \hat{\vec{x}}. In an embodiment, if this value is less than 0.03, the candidate key point is discarded. Otherwise, it can be kept for further processing, with the final scale-space location \vec{y}+\hat{\vec{x}}, where \vec{y} is the original location of the candidate key point.

In general, DoG functions have strong edge responses. In an embodiment, to make the key points resilient to small amounts of noise, candidate key points that are potential noise need to be eliminated. This can be done by solving for the Eigenvalues of the second-order Hessian matrix \vec{H}:

$$\vec{H} = [ \begin{matrix}{D}_{xx} & {D}_{xy} \\ {D}_{xy} & {D}_{yy}\end{matrix} ] \qquad ( 4 )$$

The ratio r of the larger eigenvalue α to the smaller one β is sufficient for use in the filtering process of SIFT, i.e. r=α/β. For ease of calculation, the trace of \vec{H}, Dₓₓ+D_{yy}, yields the sum of the two eigenvalues, and the determinant, DₓₓD_{yy}−D_{xy}², yields the product. The ratio

$$R = \frac{{Tr ( \vec{H} )}^{2}}{Det ( \vec{H} )} = \frac{{( r + 1 )}^{2}}{r} .$$

To detect poorly localized key points, SIFT can use a threshold

$${r}_{th} = 10. If R > \frac{{( {r}_{th} + 1 )}^{2}}{{r}_{th}} ,$$

then that key point can be rejected.

### 2.2 Orientation Assignment and Key Point Descriptor

In an embodiment, to determine the orientation of the image, each key point is assigned one or more orientations based on the direction of the local image gradient. This step allows SIFT to be invariant to rotations as the key point descriptor that will be created is relative to this orientation. In an embodiment, the first step is to take the Gaussian-smoothed image L(x, y, σ) at the key point's scale σ to make it invariant to scale. Therefore, for an image sample L(x, y) at scale σ, the gradient magnitude m(x, y) and orientation θ(x, y) can be precomputed using pixel differences, i.e.:

$$m ( x , y ) = \sqrt{{( L ( x + 1 , y ) - L ( x - 1 , y ) )}^{2} + {( L ( x , y + 1 ) - L ( x , y - 1 ) )}^{2}} \qquad ( 5 )$$

$$θ ( x , y ) = a {tan}_{2} ( L ( x , y + 1 ) - L ( x , y - 1 ) , L ( x + 1 , y ) - L ( x - 1 , y ) )$$

Next, in an embodiment, an orientation histogram is formed with 36 bins (one bin for every 10 degrees). Each sample in the neighboring window can be added to the appropriate histogram bin and weighted by their gradient magnitude as well as by a Gaussian-weighted circular window with a σ that is 1.5 times the scale of the key point. Once the histogram has been computed, the orientations that are within 80% can be assigned to the key point.

In an embodiment, to create a Key Point Descriptor from these key points that are invariant to location, scale and rotation, a 128 dimensional vector is created through the following process. First, a set of orientation histograms can be created on 4×4 pixel neighborhoods with 8 bins each. These histogram can be created from the magnitude and orientation values of samples in a 16×16 region around the key point such that each histogram contains samples from a 4×4 subregion of the original region. The scale 6 for the key point can be used to generate a Gaussian-blurred image and can be further weighted by another Gaussian function with a 6=0.2 (empirically chosen). The final vector can be created from the 4×4 subregions (16 histograms), and each histogram can have 8 bins which yields the 128 dimensional vector for the key point descriptor. This vector can then be normalized for invariance to scale and can be used to match the key points that make up an object in a test image.

SIFT's can be used in the field of object recognition and can detect multiple images in satellite imagery. It can be used to detect, place, and describe 3D objects using an affine transformation with a single camera (as opposed to stereo cameras). Other uses include robot localization, image reconstruction, remote sensing, and panoramic image stitching (note that this is not an exhaustive list of applications).

### 2.3 ORB

Oriented FAST and Rotated BRIEF (ORB) can be used as an efficient and alternative to SIFT. In an embodiment, at a high-level, FAST is an efficient corner detector, BRIEF is a feature detector, and ORB builds on both of these to find key points in a given image for matching in a similar fashion as SIFT. In an embodiment, ORB is faster than SIFT and Speeded Up Robust Features (SURF) for most applications.

2.4 FAST: Features from Accelerated Segment Test

In an embodiment, FAST can be used to detect corners in digital images. In an embodiment, FAST can use the following process. 1. Select a pixel p that is a candidate corner point. Its intensity can be defined as Iₚ. 2. Select an appropriate threshold value t. 3. Calculate a circle of 16 pixels around p (Bresenham circle r=3). 4. p is a corner if there exists a set of n contiguous pixels in the circle which are all brighter than Iₚ+t, or all darker than Iₚ−t. 5. To speed up the process, the intensity of pixels of 1, 5, 9, and 13 can be compared with Iₚ. If at least 3 of the 4 pixels satisfy this condition, then p as a corner exists. 6. If at least three of the four pixel values of 1, 5, 9, and 13 are not above or below Iₚ+t, then check all pixels on the circle and see if 12 pixels fall within the criterion. 7. Repeat for all pixels in the image. In an embodiment, there are a couple of limitations to this process. First, if n<12, it has a tendency to find false corners. This implies that n is most likely sensitive to the resolution of the images under consideration. Second, if the corner isn't oriented so that the first test catches it, the algorithm slows down.

To deal with these problems, a Machine Learning (ML) approach can be used. For example, the following process can be used: 1. Select a training set of images from the target domain. 2. Run FAST on every image to find the corner/feature points. 3. For every corner/feature point, store the 16 pixels around it as a vector. Perform this for all images to generate feature vector \hat{p}. 4. Each pixel x in these 16 pixels can have one of three states:

$${S}_{\hat{p} \to x} = \{ \begin{matrix}{I}_{\hat{p} \to x} \leq {I}_{p} - t & d , ( darker ) \\ {I}_{p} - t < {I}_{\hat{p} \to x} < {I}_{p} + t & s , ( similar ) \\ {I}_{p} + t \leq {I}_{\hat{p} \to x} & b , ( brighter )\end{matrix} \qquad ( 6 )$$

5. Depending on the states, the feature vector \hat{p} is placed into three subsets \hat{p}_{d}, \hat{p}ₛ, and \hat{p}_{b}. 6. Define a variable Kₚ which is true if p is an interest point and false if it is not. 7. Use the ID3 algorithm to query each subset using the variable Kₚ to find the true class labels. 8. ID3 operates on the principle of reducing entropy; i.e. find the pixel x which has the most information about pixel p. 9. The entropy for the set P is represented by:

$$\{ \begin{matrix}H ( P ) & = ( c + \overline{c} ) {log}_{2} ( c + \overline{c} ) - c {log}_{2} c - \overline{c} {log}_{2} \overline{c} \\ where c & = \vert p ∈ {K}_{p} \vert ( number of corners ) \\ and c & = \vert p ∉ {K}_{o} \vert ( number of non - corners )\end{matrix} \qquad ( 7 )$$

10. Recursively apply H(P) to all subsets until the entropy is zero. 11. The decision tree created is then used for FAST detection in other images. A problem with this ML approach is that there could be multiple points of interest that are shared in the circle. The solution to this is to apply Non-maximal Suppression: 1. Compute a score function V for all detected feature points. V is given by:

$$V = {\sum }_{i = 1}^{n} \vert p - {B}_{i} \vert \qquad ( 8 )$$

where Bᵢ are points on the Bresenham circle around pixel p (n=16 in practice). 2. Consider two adjacent feature/key points and compute their V values. 3. Discard the point with the lower V value.

In an embodiment, a problem with FAST is that it expects crisp corners on an X-Y axis (i.e. a standard digital images). For use in ORB, this will be oriented to detect corners of an object even if it was rotated. One can also use a Gaussian blur to help alleviate this problem.

### 2.5 BRIEF

FAST can be used as a method to calculate a key point/feature. In an embodiment, the next problem is how to quickly match the key points to a known object in a manner that similar to SIFT. One major drawback to SIFT is that it uses a 128-dimensional feature vector to describe a key point, and as the number of key points grows, significant computational overhead is incurred. Some potential approaches to deal with this problem include (1) Principle Component Analysis (PCA) or Linear Discriminant Embedding (LDE); (2) Reduce the number of bits in the SIFT descriptor or change floating points to integers (use Hamming distance for matching); and (3) Convert the descriptor to binary and use Locally Sensitive Hashing (LSH) and Hamming distance to match.

While these methods help to give a speed increase with SIFT, it is still computationally expensive. SURF can be used to address this problem; however, as n, the number of points, increases it starts to have significant slow-downs as well. BRIEF can be used to address these problems. In an embodiment, to start, define a test τ on patch p of size S×S as:

$$τ ( p ; x , y ) = \{ \begin{matrix}1 & if p ( x ) < p ( y ) , \\ 2 & otherwise\end{matrix} \qquad ( 9 )$$

where p(x) is the pixel intensity in a smoothed version of p at x=(u, v)^{T}. Choosing a set of n_{d}(x, y) location pairs uniquely defines a set of binary tests. This is the BRIEF descriptor and is a n-dimensional string:

$${f}_{{n}_{d}} ( p ) = {\sum }_{1 \leq i ⩽ {n}_{d}} {2}^{i - 1} τ ( p ; {x}_{i} , {y}_{i} ) \qquad ( 10 )$$

In an embodiment, to perform the patch test, Uniform and Gaussian smoothing kernels can be used. In an embodiment, to address many of the shortcomings previously mentioned, ORB can be used to produce results similar but faster to SIFT. In an embodiment, the major contributions of BRIEF include: (1) the addition of a fast and accurate orientation component to FAST; (2) the efficient computation of oriented BRIEF Features; (3) analysis of variance and correlation of oriented BRIEF features; and (4) a learning model for de-correlating BRIEF features under rotational invariance, which boosts performance in nearest-neighbor applications. FAST features are computationally efficient; however, they are sensitive to rotation. In ORB, the corner orientation is given by calculating the intensity centroid of the patch. First, the moment of the patch under consideration is calculated:

$${m}_{pq} = {\sum }_{x , y} {x}^{p} {y}^{q} I ( x , y ) \qquad ( 11 )$$

which can be used to find the centroid:

$$C = ( \frac{{m}_{10}}{{m}_{00}} , \frac{{m}_{01}}{{m}_{00}} ) \qquad ( 12 )$$

Finally, a vector is constructed from the corner's center, O, to the centroid, \vec{OC}. This is used with the quadrant aware version of arctan, arctan 2, to find the orientation θ of the patch:

θ=arctan 2(m₀₁,m₁₀) (13)

In an embodiment, BRIEF uses equations 9 and 10, along with a 5×5 test patch in a 31×31 pixel window of a larger patch to generate the ORB feature vector. Note that, in an embodiment, these numbers (5×5 and 31×31) are determined empirically based on the data. Finally, to make brief invariant to in-plane rotation, a set of rotation and perspective warps can be used for each patch; however, these are computationally expensive. In an embodiment, ORB uses a more efficient steering method. In an embodiment, this works by taking a feature set of n binary tests at location (xᵢ, yᵢ) and using it to define a 2×n matrix:

$$S = ( \begin{matrix}{x}_{1} , & … , & {x}_{n} \\ {y}_{1} , & … , & {y}_{n}\end{matrix} ) \qquad ( 14 )$$

Using the patch orientation θ and the corresponding rotation matrix R_{θ}, a steered version S_{θ} of S can be constructed as:

S_{θ}=R_{θ}S (15)

This can be used to yield the steered BRIEF operator:

gₙ(p,θ)=fₙ(p)|(xᵢ,yᵢ)∈S_{θ} (16)

The methods used to create BRIEF allow for key points to be robustly matched in a manner similar to SIFT.

### 3. LANDMARK DETECTION AND SEGMENTATION

In an embodiment, object detection is a technique for locating and drawing bounding boxes around objects to the nearest degree possible and assigning class labels to those bounding boxes. In an embodiment, neural networks can be used to locate buildings in data-sets from around the world; however, the coarseness of the bounding box locations can result in a higher fidelity method for geolocating specific points on a map at the pixel level.

In an embodiment, data augmentation can be used when training the neural networks. In an embodiment, this is the practice of perturbing a smaller set by blurring, obscuring, zooming, flipping, rotating, etc., to create a larger set of training data. In an embodiment, not only does this create a larger data-set for training, but these distortions also attempt to teach the model how to handle a broader scope of images it may encounter in the field. The concept of adding in external information to the raw imagery data can be a very rich line of research that is useful for GeoINT applications. Previously data-sets have been very stagnate sets of images with head on perspective with ImageNet or at unknown angles for the MS-COCO data-set used for autonomous driving algorithms. The regimental nature of satellite orbits gives us in the Bayesian worldview a set of priors. To incorporate these priors there is typically either the tact of preprocessing input data to a network or post-processing results. Post-processing can be used to add geometric constraints that a specific object is between a minimum and maximum size in pixels.

In an embodiment, image (a.k.a. semantic) segmentation is the technique used to assign a class on a pixel-by-pixel basis. An example includes deciphering which pixels are part of a road and which are not a road. Using a U-Net architecture, a convolutional network used for fast and precise segmentation of images, pixels can be labeled as either a road or not-road, creating a topography of nodes and connections outlining where the model predicts a road is. Taking into account object detection and its ability to detect objects of interest at a lower level of precision, semantic segmentation can provide more precise information about where objects of interest are located in the image. This precise information can provide stronger information for localizing landmarks.

In an embodiment, the metric of performance used can be F1-Scores or a variation of Intersection-over-Union (IoU). In an embodiment, this performance attempts to score a models ability to identify, on a pixel-by-pixel basis, the pixel value predicted with the pixel value of the ground truth image. Other metrics also employ a technique to score how well the predicted graph matches up with the ground truth graph through graph theory based upon shortest path algorithms. In an embodiment, the two techniques of object detection and image segmentation can be combined, using object detection as a means of locating an object of interest and deploying image segmentation to decipher our area of interest to a more granulated precision.

### 4. ESTIMATING AN OFFSET IN THE EARTH ROTATION ANGLE

This section describes the observability of additionally estimating an offset in the Earth Rotation Angle (ERA) from measurements of landmarks on Earth's surface in accordance with embodiments of the present disclosure. Though the term ERA will be used in this section, it is not limited to Earth—the analysis is general enough it applies to any similar bodies.

In an embodiment, for a measurement model, assume a simplified model of Earth's rotation where the ERA is

θ(t)=θ₀+ω_{⊕}t (17)

with

R_{E→H}=R_{\hat{k}}(nt)R_{î}(i)R_{\hat{k}}(Ω)R_{\hat{k}}(−θ) (18)

where ω_{⊕} is the angular velocity of the Earth. The θ₀ is an additional state to be estimated. The transformation from the Earth fixed to the Hill frame can be represented by:

r^{H}=R_{E→H}r^{E}−αî (19)

with

R_{E→H}=R_{\hat{k}}(nt)R_{î}(i)R_{\hat{k}}(Ω)R_{\hat{k}}(−θ) (20)

where R_{â}(b) is a frame rotation constructed from the given axis and angle, i is inclination, Ω is right ascension of the ascending node, and θ is true anomaly. The additional term in the measurement equation is

$$\begin{matrix}\frac{\partial d}{\partial {θ}_{0}} = \frac{\partial {r}_{g}^{H}}{\partial {θ}_{0}} \\ = {R}_{\hat{k}} ( nt ) {R}_{i} ( i ) {R}_{\hat{k}} ( Ω ) \frac{\partial {R}_{\hat{k}} ( - θ )}{\partial θ} \frac{\partial θ}{\partial {θ}_{0}} {r}_{g}^{E} \\ = {R}_{\hat{k}} ( nt ) {R}_{i} ( i ) {R}_{\hat{k}} ( Ω ) {{R}_{\hat{k}} ( - θ ) [ \hat{k} ]}_{\times } {r}_{g}^{E} \\ = {{R}_{E \to H} [ \hat{k} ]}_{\times } {r}_{g}^{E}\end{matrix} \qquad ( 21 )$$

where [·]ₓ is the cross product matrix. Now evaluated along the nominal trajectory r_{g}^{H}=d so the previous equation can be written in terms of d instead of r_{g}.

$$\begin{matrix}\frac{\partial d}{\partial {θ}_{0}} = {{R}_{E \to H} [ \hat{k} ]}_{\times } {R}_{E \to H}^{T} ( d + ai ) \\ = {R}_{\hat{k}} ( nt ) {{R}_{i} ( i ) [ \hat{k} ]}_{\times } {R}_{i} ( - i ) {R}_{\hat{k}} ( - nt ) ( d + ai )\end{matrix} \qquad ( 22 )$$

The last simplification is possible because cross products commute with rotations if they are about the same axis. For easier notation the previous equation will be written as

$$\frac{\partial d}{\partial {θ}_{0}} = e = E ( d + ai ) \qquad ( 23 )$$

and it is noted that E is skew symmetric and time dependent. The entries of E are

$$[ \begin{matrix}0 & - {x}_{i} & {c}_{n} {s}_{i} \\ {c}_{i} & 0 & - {s}_{n} {s}_{i} \\ - {c}_{n} {s}_{i} & {s}_{n} {s}_{i} & 0\end{matrix} ] \qquad ( 24 )$$

where cₙ=cos(nt), sₙ=sin(nt), ci=cos(i), and si=sin (i). The new measurement equation is

$$H = \frac{1}{d} {H}_{\hat{d}} [ \begin{matrix}\begin{matrix}- I & 0\end{matrix} & e ]\end{matrix} \qquad ( 25 )$$

where the state vector has been augmented with θ₀. Assuming \hat{d} is constant in the Hill frame, all landmarks are on Earth, and further assume a spherical Earth so that d does not vary. Then the only time varying component of the measurement equation is E.

For a process model, integrating and augmenting with θ₀ gives the solution

$$X ( t ) = [ \begin{matrix}{Φ}_{rr} & {Φ}_{rv} & 0 \\ {Φ}_{vr} & {Φ}_{vv} & 0 \\ 0 & 0 & 1\end{matrix} \qquad ( 26 )$$

$$with$$

$${Φ}_{rr} = [ \begin{matrix}4 - 3 {c}_{n} & 0 & 0 \\ 6 ( {s}_{n} - nt ) & 1 & 0 \\ 0 & 0 & {c}_{n}\end{matrix} ] \qquad ( 27 )$$

$${Φ}_{rv} = [ \begin{matrix}\frac{1}{n} {s}_{n} & \frac{2}{n} ( 1 - {c}_{n} ) & 0 \\ \frac{2}{n} ( {c}_{n} - 1 ) & \frac{1}{n} {s}_{n} - 3 t & 0 \\ 0 & 0 & \frac{- 1}{n} {s}_{n}\end{matrix} ]$$

where sₙ=sin(nt) and cₙ=cos(nt).

For observability, let (t)=H(t)X(t). The integral condition for observability is the linear independence of the columns of Ψ(t). The system is observable in the interval [t₀, t₁] iff there is no nonzero vector x such that Ψ(t)x=0 for almost all t∈[t₀, t₁]. The phrase “almost all” can be defined to mean everywhere except at a countable set of points. The system given by (25) and (26) is observable iff the following are true: (1) n>0; (2) d≠∞; (3) \hat{d}^{T}î≠0; (4) \hat{d}^{T}ĵ≠0; (5) \hat{d}^{T}\hat{k}≠0; and (6) i≠π/2.

Proof: First construct Ψ from (25) and 26).

$$Ψ = H ( t ) X ( t ) = \frac{1}{d} {H}_{\hat{d}} [ \begin{matrix}\begin{matrix}{Φ}_{rr} & {Φ}_{rv}\end{matrix} & e ]\end{matrix} \qquad ( 28 )$$

Then solve Ψₓ=0.

$$\frac{1}{d} {H}_{\hat{d}} [ \begin{matrix}\begin{matrix}{Φ}_{rr} & {Φ}_{rv}\end{matrix} & e ] x = 0\end{matrix} \qquad ( 29 )$$

$${H}_{\hat{d}} [ \begin{matrix}\begin{matrix}{Φ}_{rr} & {Φ}_{rv}\end{matrix} & e ] x = 0\end{matrix}$$

$$[ \begin{matrix}\begin{matrix}{Φ}_{rr} & {Φ}_{rv}\end{matrix} & e ] x = α ( t ) d\end{matrix}$$

where α(t) is any function of time. The above assumes d≠0 and d≠∞. Expanding the last equation and grouping in terms of orthogonal functions of time gives the system of equations

d₁α(t)=cₙk₁+sₙk₂+k₃

d₂α(t)=cₙk₄+sₙk₅+tk₆+k₇

d₃α(t)=cₙk₈+sₙk₉ (30)

with

$${k}_{1} = {3}_{{r}_{1}} + \frac{2}{n} {v}_{2} + {s}_{i} {d}_{3} {θ}_{0} \qquad ( 31 )$$

$${k}_{2} = \frac{- 1}{n} {v}_{1}$$

$${k}_{3} = - 4 {r}_{1} - \frac{2}{n} {v}_{2} - {c}_{i} {d}_{2} {θ}_{0}$$

$${k}_{4} = \frac{- 2}{n} {v}_{1}$$

$${k}_{5} = - 6 {r}_{1} - \frac{4}{n} {v}_{2} - {s}_{i} {d}_{3} {θ}_{0}$$

$${k}_{6} = {6}_{{nr}_{1}} + {3}_{v2}$$

$${k}_{7} = - {r}_{2} + \frac{2}{n} {v}_{1} + ( a + {d}_{1} ) {c}_{i} {θ}_{0}$$

$${k}_{8} = - {r}_{3} - ( a + {d}_{1} ) {s}_{i} {θ}_{0}$$

$${k}_{9} = \frac{- 1}{n} {v}_{3} + {s}_{i} {d}_{2} {θ}_{0}$$

where x=[r₁ r₂ r₃ v₁ v₂ v₃ θ₀]^{T}. Now each of the equations (30) can be satisfied either when dⱼ=0 or when α(t) is the right hand side divided by the corresponding dⱼ. From the assumptions deriving the measurement equation (the landmark is on the Earth) d₁≠0. This leaves four possible cases to check: (1) d₁≠0, d₂=0, d₃=0; (2) d₁≠0, d₂≠0, d₃=0; (3) d₁≠0, d₂=0, d₃≠0; and (4) d₁≠0, d₂≠0, d₃≠0.

Case 1—

d₂=0⇒k₄=0⇒v₁=0

k₅=0⇒v₂=−2nr₁

k₆=0⇒r₁=0⇒v₂=0

k₇=0⇒r₂=(a+d₁)cᵢθ₀

d₃=0⇒k₈=0⇒r₃=−(a+d₁)sᵢθ₀

k₉=0⇒v₃=0 (32)

Now (a+d1) 6=0 since the landmark is not at the center of the Earth. That leaves two possible solutions.

$$\{ \begin{matrix}{r}_{2} = 0 & {c}_{i} = 0 \\ {θ}_{0} = \frac{1}{( a + {d}_{1} ) \text{?}} {r}_{2} & {c}_{i} \neq 0\end{matrix} \qquad ( 33 )$$

$$\text{?} \text{indicates text missing or illegible when filed}$$

In the later case r3=−tan(i)r₂ though in both cases θ₀ is left as a free variable. Therefore case 1 is unobservable because there is a non-zero θ₀ such that Ψₓ=0 for all t.

$$\begin{matrix}\text{?} Case 2 - & \\ d \text{?} = 0 ⟹ {k}_{8} = 0 ⟹ {r}_{3} = - ( a + {d}_{1} ) {s}_{i} {θ}_{0} & ( 34 )\end{matrix}$$

$${k}_{9} = 0 ⟹ {v}_{3} = \text{?} {d}_{2} {θ}_{0}$$

$$α ( t ) = \frac{{c}_{n} {k}_{1} + {s}_{n} {k}_{2} + {k}_{3}}{{d}_{1}} = \frac{{c}_{n} {k}_{1} + {s}_{n} {k}_{5} + {tk}_{6} + {k}_{7}}{{d}_{2}}$$

$$⟹ {k}_{6} = 0 ⟹ {v}_{2} = - 2 {nr}_{1}$$

$$⟹ {d}_{2} {k}_{1} = {d}_{1} {k}_{4} ⟹ {v}_{1} = \frac{{nd}_{2}}{2 {d}_{1}} {r}_{1}$$

$$⟹ {d}_{2} {k}_{2} = {d}_{2} k \text{?} ⟹ {r}_{1} = 0 = {v}_{2} = {v}_{1}$$

$$⟹ {d}_{2} {k}_{3} = {d}_{1} {k}_{7} ⟹ {r}_{2} = \frac{{d}_{1} ( a + {d}_{1} ) + {d}_{2}^{2}}{{d}_{1}} {c}_{i} {θ}_{0}$$

$$\text{?} \text{indicates text missing or illegible when filed}$$

In the case r₂, r₃, and v₃ are functions of the free variable θ₀. Therefore case 2 is also unobservable.

$$\begin{matrix}Case 3 - & \\ {d}_{2} = 0 ⟹ {k}_{4} = 0 ⟹ {v}_{1} = 0 & ( 35 )\end{matrix}$$

$${k}_{6} = 0 ⟹ {v}_{2} = - 2 {nr}_{1}$$

$${k}_{5} = 0 ⟹ {r}_{1} = \frac{1}{2} {s}_{i} {d}_{3} {θ}_{0}$$

$${k}_{7} = 0 ⟹ {r}_{2} = ( a + {d}_{1} ) {c}_{i} {θ}_{0}$$

$$α ( t ) = \frac{{c}_{n} {k}_{1} + {s}_{n} {k}_{2} + {k}_{3}}{{d}_{1}} = \frac{{c}_{n} k \text{?} + {s}_{n} {k}_{0}}{{d}_{3}}$$

$$⟹ {k}_{3} = 0 ⟹$$

$$⟹ {d}_{3} {k}_{1} = {d}_{1} k \text{?} ⟹$$

$${r}_{3} = - \frac{\frac{1}{2} {d}_{3}^{2} + {d}_{1} ( a + {d}_{1} )}{{d}_{1}} {s}_{i} {θ}_{0}$$

$$⟹ {d}_{3} {k}_{2} = {d}_{1} {k}_{9} ⟹ {v}_{3} = 0$$

$$\text{?} \text{indicates text missing or illegible when filed}$$

The condition k₃=0 implied no additional constraints. In this case r₁, r₃, and v₂ are functions of the free variable θ₀. Therefore case 3 is also unobservable.

$$\begin{matrix}Case 4 - & \\ α ( t ) = \frac{{c}_{n} {k}_{1} + {s}_{n} {k}_{2} + {k}_{3}}{{d}_{1}} = \frac{{c}_{n} {k}_{4} + {s}_{n} {k}_{5} + {tk}_{0} + {k}_{7}}{{d}_{2}} = \frac{{d}_{n} {k}_{8} + {s}_{n} {k}_{9}}{{d}_{3}} & ( 36 )\end{matrix}$$

$$⟹ {k}_{6} = 0 ⟹ {v}_{2} = - 2 {nr}_{1}$$

$$⟹ k \text{?} = 0 ⟹ {c}_{i} {θ}_{0} = 0$$

$$⟹ {k}_{7} = 0 ⟹ {v}_{1} = \frac{n}{2} {r}_{2}$$

$$⟹ {d}_{2} {k}_{1} = {d}_{1} k \text{?} ⟹ {r}_{1} = \frac{{d}_{1}}{{d}_{2}} {r}_{2} + {s}_{i} {d}_{3} {θ}_{0}$$

$$⟹ {d}_{2} {k}_{2} = {d}_{1} {k}_{5}$$

$$⟹ {r}_{1} = \frac{2 {d}_{1}^{2} + {d}_{2}^{2}}{4 {d}_{1}^{2} + {d}_{2}^{2}} {s}_{i} {d}_{3} {θ}_{0}$$

$$⟹ {r}_{2} = \frac{- 2 {d}_{1} + {d}_{2}}{4 {d}_{1}^{2} + {d}_{2}^{2}} {s}_{i} {d}_{3} {θ}_{0}$$

$$⟹ {v}_{1} = - n \frac{{d}_{1} {d}_{2}}{4 {d}_{1}^{2} + {d}_{2}^{2}} {s}_{i} {d}_{3} {θ}_{0}$$

$$⟹ {v}_{2} = - 2 n \frac{2 {d}_{1}^{2} + {d}_{2}^{2}}{4 {d}_{1}^{2} + {d}_{2}^{2}} {s}_{i} {d}_{3} {θ}_{0}$$

$$⟹ {d}_{2} k \text{?} = {d}_{3} {k}_{4}$$

$$⟹ {r}_{3} = - ( ( a + {d}_{1} ) + \frac{2 {d}_{1} {d}_{3}^{2}}{4 {d}_{1}^{2} + {d}_{2}^{2}} ) {s}_{i} {θ}_{0}$$

$$⟹ {d}_{1} k \text{?} = {d}_{3} {k}_{2}$$

$$⟹ {v}_{3} = - n ( - {d}_{2} + \frac{{d}_{2} {d}_{3}^{2}}{4 {d}_{1}^{2} + {d}_{2}^{2}} ) {s}_{i} {θ}_{0}$$

$$\text{?} \text{indicates text missing or illegible when filed}$$

The condition ⇒k₃=0⇒cᵢθ₀=0 has two solutions:

$$\{ \begin{matrix}{c}_{i} = 0 & {θ}_{0} \neq 0 \\ {θ}_{0} = 0 & {c}_{i} \neq 0\end{matrix} \qquad ( 37 )$$

In the former case θ₀ is a free variable so it is unobservable. In the later case r₁ through v₃ are zero since they are a scalar multiple of θ₀. Therefore in that case, the system is observable because there is no nonzero x that satisfies Ψx=0. Since 0≤i≤π, cᵢ≠0 implies i≠π/2.

Though the unobservable directions have zero area on the celestial sphere and the unobservable inclination is a single point they do have important implications for spacecraft operations. Namely that under the assumptions, the spacecraft looks both cross-track as well as in-track when collecting observations and that spacecraft in exactly polar orbits will not be able to estimate an ERA offset.

When the orbit is polar, a measured in-track or radial bias no longer contains any information about the ERA, as it would for other inclinations. In an embodiment, this leads to the remaining six state variables becoming inseparable for an ERA bias. The popular Sun-Synchronous Orbit (SSO) has an inclination near, but greater than π/2. So a SSO has at least theoretical observability.

### 5. ESTIMATING AN THE EARTH'S POLE WITH RESPECT TO ITS CRUST

This section describes the observability of additionally estimating the motion of Earth's pole with respect to its crust, extending the analysis of the previous section. Only cases where the spacecraft state and ERA are observable will be considered.

For a measurement model, a simplified model of polar motion is the rotation matrix

$$W = [ \begin{matrix}1 & 0 & - {x}_{p} \\ 0 & 1 & {y}_{p} \\ {x}_{p} & - {y}_{p} & 1\end{matrix} ] \qquad ( 38 )$$

where xp and yp are the coordinates of the pole, which are assumed to be small angles. The pole coordinates (xₚ, yₚ) are appended to the state vector as two additional states to be estimated and, for simplicity, are assumed to be constant over the estimation interval. Let E* be the Earth fixed frame with polar motion. Then, as before, the transformation to the Hill frame can be written and derivatives of d computed to form the linearized measurement model.

$${r}^{H} = {R}_{E \to H} {Wr}^{{E}^{⋆}} - \text{?} \qquad ( 39 )$$

$$\frac{\partial d}{\partial {x}_{p}} = {R}_{E \to H} [ \text{?} ] \text{?} {R}_{E \to H}^{T} ( d + \text{?} ) \qquad ( 40 )$$

$$\frac{\partial d}{\partial {y}_{p}} = {R}_{E \to H} [ \text{?} ] \text{?} {R}_{E \to H}^{T} ( d + \text{?} ) \qquad ( 41 )$$

$$\text{?} \text{indicates text missing or illegible when filed}$$

The new measurement equation is

$$H = \frac{1}{d} {H}_{d} [ \begin{matrix}\begin{matrix}- I & 0\end{matrix} & F ]\end{matrix} \qquad ( 42 )$$

$$with$$

$$\text{?} = {R}_{E \to H} [ \begin{matrix}\begin{matrix}{⌊ \hat{k} ⌋}_{\times } & \text{?}\end{matrix} & \text{?}\end{matrix} ] {R}_{E \to H}^{T} ( d + a \text{?} ) \qquad ( 43 )$$

$$\text{?} \text{indicates text missing or illegible when filed}$$

For a process model, augmenting the state vector with two additional constant states, (xₚ, yₚ), gives the integrated solution

$$X ( t ) = [ \begin{matrix}{Φ}_{rr} & {Φ}_{rv} & 0 \\ {Φ}_{vr} & {Φ}_{vv} & 0 \\ 0 & 0 & I\end{matrix} ] \qquad ( 44 )$$

and brings the dimension of the state vector to 9.

For observability, first construct Ψ from (42) and (43).

$$Ψ = H ( t ) X ( t ) = \frac{1}{d} {H}_{\hat{d}} [ \begin{matrix}\begin{matrix}{Φ}_{rr} & {Φ}_{rv}\end{matrix} & F\end{matrix} ] \qquad ( 45 )$$

Then solve Ψx=0.

$$\frac{1}{d} {H}_{\hat{d}} [ \begin{matrix}\begin{matrix}{Φ}_{rr} & {Φ}_{rv}\end{matrix} & F ] x = 0\end{matrix} \qquad ( 46 )$$

$${H}_{\dot{d}} [ \begin{matrix}\begin{matrix}{Φ}_{rr} & {Φ}_{rv}\end{matrix} & F ] x = 0\end{matrix} \qquad ( 47 )$$

$$[ \begin{matrix}\begin{matrix}{Φ}_{rr} & {Φ}_{rv}\end{matrix} & F ] x = a ( t ) d\end{matrix} \qquad ( 48 )$$

where α(t) is any function of time. The above assumes d≠0 and d≠∞. Expanding the last equation and grouping in terms of functions of time gives the system of equations:

d₁α(t)=cₙk₁₁+sₙk₁₂+k₁₃+k₁₄c_{ω}_{_{⊕}}+k₁₅s_{ω}_{_{⊕}}+k₁₆c₊+k₁₇s₊+k₁₈c₋+k₁₉s₋ (49)

d₂α(t)=cₙk₂₁+sₙk₂₂+k₂₃+k₂₄c_{ω}_{_{⊕}}+k₂₅s_{ω}_{_{⊕}}+k₂₆c₊+k₂₇s₊+k₂₈c₋+k₂₉s₋tk₂₀ (50)

d₃α(t)=cₙk₃₁+sₙk₃₂+k₃₆c₊+k₃₇s₊+k₃₈c₋+k₃₉s₋ (51)

where

c_{ω}_{_{⊕}}=cos(ω_{⊕}t) (52)

s_{ω}_{_{⊕}}=sin(ω_{⊕}t) (53)

c₊=cos((ω_{⊕}+n)t) (54)

s₊=sin((ω_{⊕}+n)t) (55)

c₋=cos((ω_{⊕}−n)t) (56)

s₋=sin((ω_{⊕}−n)t) (57)

The coefficients are:

$${k}_{11} = {d}_{3} {θ}_{0} {s}_{i} + \frac{2 {v}_{2}}{n} \qquad ( 58 )$$

$${k}_{12} = - \frac{{v}_{1}}{n}$$

$${k}_{13} = - {d}_{2} {θ}_{0} {c}_{i} - 4 {r}_{1} - \frac{2 {v}_{2}}{n}$$

$${k}_{14} = {d}_{2} {s}_{i} ( - {c}_{Ω} {x}_{p} + {s}_{Ω} {y}_{p} )$$

$${k}_{15} = {d}_{2} {s}_{i} ( - {s}_{Ω} {x}_{p} - {c}_{Ω} {y}_{p} )$$

$${k}_{16} = \frac{1}{2} {d}_{3} ( {c}_{i} - 1 ) ( - {c}_{Ω} {x}_{p} + {s}_{Ω} {y}_{p} )$$

$${k}_{17} = \frac{1}{2} {d}_{3} ( {c}_{i} - 1 ) ( - {s}_{Ω} {x}_{p} - {c}_{Ω} {y}_{p} )$$

$${k}_{18} = \frac{1}{2} {d}_{3} ( {c}_{i} + 1 ) ( - {c}_{Ω} {x}_{p} - {s}_{Ω} {y}_{p} )$$

$${k}_{19} = \frac{1}{2} {d}_{3} ( {c}_{i} + 1 ) ( - {s}_{Ω} {x}_{p} - {c}_{Ω} {y}_{p} )$$

$${k}_{20} = 6 {nr}_{1} + {3}_{v 2}$$

$${k}_{21} = - \frac{{2}_{v 1}}{n}$$

$${k}_{22} = - {d}_{3} {θ}_{0} {s}_{i} - 6 {r}_{1} - \frac{4 {v}_{2}}{n}$$

$${k}_{23} = ( a + {d}_{1} ) {θ}_{0} {c}_{i} - {r}_{2} + \frac{2 {v}_{1}}{n}$$

$${k}_{24} = ( a + {d}_{1} ) {s}_{i} ( {c}_{Ω} {x}_{p} - {s}_{Ω} {y}_{p} )$$

$${k}_{25} = ( a + {d}_{1} ) {s}_{i} ( {s}_{Ω} {x}_{p} + {c}_{Ω} {y}_{p} )$$

$${k}_{26} = \frac{1}{2} {d}_{3} ( {c}_{i} - 1 ) ( - {s}_{Ω} {x}_{p} - {c}_{Ω} {y}_{p} )$$

$${k}_{27} = \frac{1}{2} {d}_{3} ( {c}_{i} + 1 ) ( {c}_{Ω} {x}_{p} - {s}_{Ω} {y}_{p} )$$

$${k}_{28} = \frac{1}{2} {d}_{3} ( {c}_{i} + 1 ) ( {s}_{Ω} {x}_{p} + {c}_{Ω} {y}_{p} )$$

$${k}_{29} = \frac{1}{2} {d}_{3} ( {c}_{i} + 1 ) ( - {c}_{Ω} {x}_{p} + {s}_{Ω} {y}_{p} )$$

$${k}_{31} = - ( a + {d}_{1} ) {θ}_{o} {s}_{i} - {r}_{3}$$

$${k}_{32} = {d}_{2} {θ}_{o} {s}_{i} - \frac{{v}_{3}}{n}$$

$${k}_{36} = \frac{1}{2} ( 1 - {c}_{i} ) ( - ( {d}_{2} {s}_{Ω} + ( a + {d}_{1} ) {c}_{Ω} ) {x}_{p} - ( {d}_{2} {c}_{Ω} - ( a + {d}_{1} ) {s}_{Ω} ) {y}_{p} )$$

$${k}_{37} = \frac{1}{2} ( 1 - {c}_{i} ) ( ( {d}_{2} {c}_{Ω} - ( a + {d}_{1} ) {s}_{Ω} ) {x}_{p} - ( {d}_{2} {s}_{Ω} + ( a + {d}_{1} ) {c}_{Ω} ) {y}_{p} )$$

$${k}_{38} = \frac{1}{2} ( 1 + {c}_{i} ) ( ( - {d}_{2} {s}_{Ω} + ( a + {d}_{1} ) {c}_{Ω} ) {x}_{p} - ( {d}_{2} {c}_{Ω} + ( a + {d}_{1} ) {s}_{Ω} ) {y}_{p} )$$

$${k}_{39} = \frac{1}{2} ( 1 + {c}_{i} ) ( ( {d}_{2} {c}_{Ω} + ( a + {d}_{1} ) {s}_{Ω} ) {x}_{p} + ( - {d}_{2} {s}_{Ω} + ( a + {d}_{1} ) {c}_{Ω} ) {y}_{p} )$$

where x=[r₁ r₂ r₃ v₁ v₂ v₃ θ₀ xₚ yₚ]^{T}. The functions of t are not orthogonal for all values of n. Specifically for n=ω_{⊕} or n=2 ω_{⊕} some of the functions are equivalent. For other values of n the functions are orthogonal.

There will be three cases considered for observability with polar motion. The first case assumes no special relationship between n and ω_{⊕} and utilizes the system of equations above (49)-(51). The cases where n=ω_{⊕} and n=2_{⊕} (the will be considered next. These cases will alter the system of equations and the constraints accordingly.

The system given by (42)-(44) is observable iff the following are true: (1) the system is observable; and (2) n≠ω_{⊕} or i≠0.

Proof: The system is observable if there is no nonzero x such that Ψ(t)x=0 for almost all t with Ψ given in (45). Three cases are considered with the general case first.

For Case 1, one of the conditions from (49) and (50) is

$${d}_{2} {k}_{16} = {d}_{1} {k}_{26} \qquad ( 59 )$$

$${d}_{2} ( \frac{1}{2} {d}_{3} ( {c}_{i} - 1 ) ( - {c}_{Ω} {x}_{p} + {s}_{Ω} {y}_{p} ) ) = {d}_{1} ( \frac{1}{2} {d}_{3} ( {c}_{i} - 1 ) ( - {s}_{Ω} {x}_{p} - {c}_{Ω} {y}_{p} ) ) \qquad ( 60 )$$

which after assuming cᵢ≠1 and grouping the equation in terms of xₚ and yₚ gives:

0=(−c_{Ω}d₂+s_{Ω}d₁)xₚ+(c_{Ω}d₁+s_{Ω}d₂)yₚ (61)

Then repeating with (49) and (50) using the same assumption cᵢ≠1 results in the following:

$${d}_{2} {k}_{17} = {d}_{1} {k}_{27} \qquad ( 62 )$$

$${d}_{2} ( \frac{1}{2} {d}_{3} ( {c}_{i} - 1 ) ( - {s}_{Ω} {x}_{p} - {c}_{Ω} {y}_{p} ) ) = {d}_{1} ( \frac{1}{2} {d}_{3} ( {c}_{i} - 1 ) ( {c}_{Ω} {x}_{p} - {s}_{Ω} {y}_{p} ) ) \qquad ( 63 )$$

Adding (61) and (64) together after multiplying (61) by a factor of (s₁₀₆ d₂+c_{Ω}d₁) and (64) by a factor of (−c_{Ω}d₂−c_{Ω}d₁) results in yₚ(d₁²+d₂²)=0. Since (d₁²+d₂²)≠0, therefore yₚ=0.

Furthermore, adding (61) and (64) together after multiplying (61) by a factor of (−c_{Ω}d₂−c_{Ω}d₁) results in xₚ(d₁²+d₂²)=0. Again, since d₁²+d₂²≠0, therefore xₚ=0.

However, it will be shown that the constraint cᵢ≠1 can be removed by substituting the value cᵢ=1 elsewhere in the system. Equations (49) and (50) imply the condition

d₂k₁₈=d₁k₂₈ (65)

then expanding the coefficients gives

$${d}_{2} ( \frac{1}{2} {d}_{3} ( {c}_{i} + 1 ) ( {c}_{Ω} {x}_{p} + {s}_{Ω} {y}_{p} ) ) = {d}_{1} ( \frac{1}{2} {d}_{3} ( {c}_{i} + 1 ) ( {s}_{Ω} {x}_{p} + {c}_{Ω} {y}_{p} ) ) \qquad ( 66 )$$

which after substituting cᵢ=1 becomes

d₂(−c_{Ω}xₚ+s_{Ω}yₚ)=d₁(s_{Ω}xₚ+c_{Ω}yₚ) (67)

Rearranging the equation in terms of xₚ and yₚ results in

(−c_{Ω}d₂−s_{Ω}d₁)xₚ+(s_{Ω}d₂−c_{Ω}d₁)yₚ=₀ (68)

This process will be repeated for another condition from (49) and (50).

$${d}_{2} {k}_{19} = {d}_{1} {k}_{29} \qquad ( 69 )$$

$${d}_{2} ( \frac{1}{2} {d}_{3} ( {c}_{i} + 1 ) ( {s}_{Ω} {x}_{p} - {c}_{Ω} {y}_{p} ) ) = \qquad ( 70 )$$

$${d}_{1} ( \frac{1}{2} {d}_{3} ( {c}_{i} + 1 ) ( - {c}_{Ω} {x}_{p} + {s}_{Ω} {y}_{p} ) ) \qquad ( 71 )$$

$${d}_{2} ( - {s}_{Ω} {x}_{p} - {c}_{Ω} {y}_{p} ) = {d}_{1} ( - {c}_{Ω} {x}_{p} + {s}_{Ω} {y}_{p} ) \\ ( - {s}_{Ω} {d}_{2} - {c}_{Ω} {d}_{1} ) {x}_{p} + ( - {c}_{Ω} {d}_{2} - {s}_{Ω} {d}_{1} ) {y}_{p} = 0 \qquad ( 72 )$$

Adding (68) and (72) together after multiplying (68) by a factor of (−s_{Ω}d₂+c_{Ω}d₁) and (72) by a factor of (c_{Ω}d₂−s_{Ω}d₁) results in yₚ(d₁²+d₂²)=0. Since (d₁²+d₂²)≠0, therefore yₚ=0.

Furthermore, adding (68) and (72) together after multiplying (68) by a factor of (c_{Ω}d₂+s_{Ω}d₁) and (72) by a factor of (s_{Ω}d₂−c_{Ω}d₁) results in xₚ(d₁²+d₂²)=0. Therefore xₚ=0.

Therefore xₚ=yₚ=0 for all i. After substituting xₚ=yₚ=0 into the coefficients, the system reduces to the one in Case 4 with the equivalence k₁₁=k₁, k₁₂=k₂, k₁₃=k₃, k₂₀=k₆, k₂₁=k₄, k₂₂=k₅, k₂₃=k₇, k₃₁=k₈, and k₃₂=k₉. Therefore, the system is observable because there is no nonzero x that satisfies Ψx=0.

Case 2: n=Ω_{⊕}—After substituting n=Ω_{⊕} into (49)-(51), the new system of equations that results is as follows,

d₁α(t)=(k₁₁+k₁₄)c_{ω}_{_{⊕}}+(k₁₂+k₁₅)s_{ω}_{_{⊕}}+k₁₆c_{2ω}_{_{⊕}}+k₁₇s_{2ω}_{_{⊕}}+(k₁₃+k₁₈) (73)

d₂α(t)=(k₂₁+k₂₄)c_{ω}_{_{⊕}}+(k₂₂+k₂₅)s_{ω}_{_{⊕}}+k₂₆c_{2ω}_{_{⊕}}+k₂₇s_{2ω}_{_{⊕}}+(k₂₃+k₂₈)+tk₂₀ (74)

d₃α(t)=k₃₁c_{ω}_{_{⊕}}+k₃₂s_{ω}_{_{⊕}}+k₃₆c_{2ω}_{_{⊕}}+k₃₇s_{2ω}_{_{⊕}}+k₃₈ (75)

where

c_{ω}_{_{⊕}}=cos(ω|_{⊕}t)

s_{ω}_{_{⊕}}=sin(ω_{⊕}t)

c_{2ω}_{_{⊕}}=cos(2ω_{⊕}t)

s_{2ω}_{_{⊕}}=sin(2ω_{⊕}t) (76)

In this system of equations, d₂k₁₆=d₁k₂₆ and d₂k₁₇=d₁k₂₇ are still valid, implying xₚ=yₚ=0 with the constraint cᵢ≠1.

The constraint cᵢ≠1 cannot be removed in this case. When cᵢ=1, then k₁₆=k₂₆=k₃₆=k₁₇=k₂₇=k₃₇=0. This leaves 7 linear equations with 9 unknowns. There will be a non-zero x such that Ψx=0 when cᵢ=1.

Substituting xₚ=yₚ=0 into the coefficients reduces the system to the one considered in Case 4, so this system is observable with the added constraint cᵢ≠1.

Case 3: n=2 ω_{⊕}—After substituting in n=2 ω_{⊕} into (49)-(51), the new system of equations is as follows:

d₁α(t)=(k₁₄+k₁₈)c_{ω}_{_{⊕}}+(k₁₅−k₁₉)s_{ω}_{_{⊕}}+k₁₁c_{2ω}_{_{⊕}}+k₁₂s_{2ω}_{_{⊕}}+k₁₆c_{3ω}_{_{⊕}}+k₁₇c_{3ω}_{_{⊕}}+k₁₃ (77)

d₂α(t)=(k₂₄+k₂₈)c_{ω}_{_{⊕}}+(k₂₅−k₂₉)s_{ω}_{_{⊕}}+k₂₁c_{2ω}_{_{⊕}}+k₂₂s_{2ω}_{_{⊕}}+k₂₆c_{3ω}_{_{⊕}}+k₂₇c_{3ω}_{_{⊕}}+k₂₃+tk₂₀ (78)

d₃α(t)=k₃₈c_{ω}_{_{⊕}}−k₃₉s_{ω}_{_{⊕}}+k₃₁c_{2ω}_{_{⊕}}+k₃₂s_{2ω}_{_{⊕}}+k₃₆c_{3ω}_{_{⊕}}+k₃₇s_{3ω}_{_{⊕}} (79)

where

c_{3ω}_{_{⊕}}=cos(3ω_{⊕}t) (80)

s_{3ω}_{_{⊕}}=sin(3ω_{⊕}t) (81)

The equations d₂k₁₆=d₁k₂₆ and d₂k₁₇=d₁k₂₇ are still valid in this system, so xₚ=yₚ=0 assuming cᵢ≠1. Now it will be shown that the constraint cᵢ≠1 can be removed by substituting the values cᵢ=1 and i=0 elsewhere in the system. From (77) and (78):

d₂(k₁₄+k₁₈)=d₁(k₂₄+k₂₈) (82)

which after expanding the coefficients and substituting becomes

d₂(−c_{Ω}xₚ+s_{Ω}yₚ)=d₁(s_{Ω}xₚ+c_{Ω}yₚ) (83)

Then, rearranging the equation in terms of xₚ and yₚ results in

(−c_{Ω}d₂−s_{Ω}d₁)xₚ+(s_{Ω}d₂−c_{Ω}d₁)yₚ=0 (84)

Then repeating for another set of equations:

d₂(k₁₅−k₁₉)=d₁(k₂₅−k₂₉) (85)

d₂(−s_{Ω}xₚ−c_{Ω}yₚ)=d₁(c_{Ω}xₚ+s_{Ω}yₚ) (86)

(−s_{Ω}d₂+c_{Ω}d₁)xₚ+(−c_{Ω}d₂−s_{Ω}d₁)yₚ=0 (87)

Adding (84) and (87) together after multiplying (84) by a factor of (−s₁₀₆ d₂+c_{Ω}d₁) and (87) by a factor of (c_{Ω}d₂+s_{Ω}d₁) results in yₚ(d₁²+d₂²)=0. Since (d₁²+d₂²)≠0, therefore yₚ=0.

Furthermore, adding (84) and (87) together after multiplying (84) by a factor of (c_{Ω}d₂+s_{Ω}d₁) and (87) by a factor of (s_{Ω}d₂−c_{Ω}d₁) results in xₚ(d₁²+d₂²)=0. Therefore xₚ=0.

Therefore xₚ=yₚ=0 for all i. After substituting xₚ=yₚ=0 into the coefficients, the system reduces to the one in Case 4, so the system is observable.

To summarize the results, the constraints on the selected orbit for each case are as follows: (1) general case: i≠π/2; (2) n=ω_{⊕}: i≠π/2 and i≠0; and (3) n=2 Ω_{⊕}: i≠π/2.

The third case with n=2 ω_{⊕} resulted in the same constraints as the general case. The only additional constraint is i≠0 when n=Ω_{⊕}. This constraint means the satellite cannot be in a geostationary orbit in order for polar motion to be observable. While the geostationary orbit is only one in the set of all possible orbits it is used for many operational spacecraft because of its unique properties.

### 6. CLOCK OBSERVABILITY

It is assumed that direction measurements are made with respect to the inertial frame, for example, by a star tracker. Without clock uncertainty, the measurement frame does not matter because the frame transformation is known a priori. But now that clock uncertainty is estimated, the frame used to measure directions becomes significant. The measurement equation becomes

d¹=r_{g}¹−rₛ¹ (88)

where the superscript indicates the reference frame. The transformation from the Earth-centered inertial (ECI) frame to the Hill frame is

r^{H}=R_{z}(v(t))r¹−a₀î (89)

v(t)=nt+v_{θ} (90)

where v is the true anomaly of the nominal orbit at the given time. Therefore, the position in the inertial frame is

rₛ¹=R_{z}(−v)(r^{H}+a₀î) (91)

=R_{z}(−v)(Φᵣx₀^{H}+a₀î) (92)

where x₀^{H} is the initial position and velocity in the Hill frame. Now, taking the derivative with respect to time in the inertial frame gives

$$\frac{\partial {r}_{s}^{t}}{\partial t} = \frac{\partial {R}_{z} ( - θ )}{\partial t} ( Φ {x}_{0}^{H} + {a}_{0} \hat{i} ) + {R}_{z} ( - θ ) \frac{\partial Φ}{\partial t} {x}_{0}^{H} \qquad ( 93 )$$

taking only the first-order effects (assuming terms with x₀^{H} are negligible), and using

$$\frac{\partial {R}_{z} ( - θ )}{\partial t} = - {{nR}_{z} ( - θ ) [ \hat{k} ]}_{x} \qquad ( 94 )$$

where [\hat{k}]ₓ is the cross product matrix, results in

$$\frac{\partial {r}_{s}^{t}}{\partial t} = - {nR}_{z} ( - θ ) \hat{k} \times {a}_{0} \hat{i} \qquad ( 95 )$$

$$= - {na}_{0} {R}_{z} ( - θ ) \hat{J} \qquad ( 96 )$$

Transforming this result back to the Hill frame in order to be compatible with the process model and using the nominal trajectory (T=t) gives

$${( \frac{\partial {r}^{I}}{\partial t} )}^{H} = - {na}_{0} \hat{J} \qquad ( 97 )$$

which is the spacecraft's nominal velocity expressed in the Hill frame. Intuitively, the spacecraft would appear either behind or ahead in track due to a clock offset. Thus,

$${( \frac{\partial {d}^{I}}{\partial t} )}^{H} = - {na}_{0} \hat{J} \qquad ( 98 )$$

assuming \dot{r}_{g}^{I}=0, i.e., that the landmark is fixed in the inertial frame. This assumption of convenience with dubious physical interpretation is made so that this section may focus on the motion of the satellite.

Now assume that the spacecraft's clock time T is a linear function of true time t:

T=t−τ(t) (99)

τ(t)=τ₀+\dot{τ}₀t (100)

where τ is the clock error, τ₀ is the initial clock error, and \dot{τ}₀ is the initial clock drift. Taking derivatives,

$$\frac{\partial τ}{\partial {τ}_{0}} = 1 \qquad ( 101 )$$

$$\frac{\partial τ}{\partial {\dot{τ}}_{0}} = t \qquad ( 102 )$$

Therefore, to account for linear clock errors, the measurement and process models are updated:

$$A = [ \begin{matrix}{A}_{h} & 0 & 0 \\ 0 & 1 & 0 \\ 0 & 0 & 1\end{matrix} ] \qquad ( 103 )$$

$$H = \frac{- 1}{d} {H}_{d} [ \begin{matrix}I & 0 & {na}_{0 \hat{J}} & {na}_{0} {t}_{\hat{J}}\end{matrix} ] \qquad ( 104 )$$

$$x = {[ \begin{matrix}{r}_{1} & {r}_{2} & {r}_{3} & {v}_{1} & {v}_{2} & {v}_{3} & {τ}_{0} & {\dot{τ}}_{0}\end{matrix} ]}^{T} \qquad ( 105 )$$

The input-output map of the system, Ψ(t), is used to determine observability:

$$0 = Ψ ( t ) \qquad ( 106 )$$

$$= H ( t ) Φ ( t ) x \qquad ( 107 )$$

$$= \frac{1}{d} {H}_{\hat{d}} {Φ}_{r} ( t ) x \qquad ( 108 )$$

$$α ( t ) d = {Φ}_{r} ( t ) x \qquad ( 109 )$$

In the above equations, α(t) is any function of time, and it is assumed d≠0 and d≠∞. Expanding Φr gives

$${Φ}_{r} ( t ) = [ \begin{matrix}4 - 3 {c}_{n} & 0 & 0 & \frac{1}{n} {s}_{n} & \frac{2}{n} ( 1 - {c}_{n} ) & 0 & 0 & 0 \\ 6 ( {s}_{n} - ni ) & 1 & 0 & \frac{2}{n} ( {c}_{n} - 1 ) & \frac{4}{n} {s}_{n} - 3 t & 0 & {na}_{0} & {na}_{0} i \\ 0 & 0 & {c}_{n} & 0 & 0 & \frac{- 1}{n} {s}_{n} & 0 & 0\end{matrix} ] \qquad ( 110 )$$

from which it is clear that the second component of position, r2, and the clock bias, τ0, are inseparable since they both only appear in constant terms in the in-track direction. This renders τ0 unobservable.

Now assume that the clock bias, τ₀, is no longer estimated, but the clock drift, \dot{τ}₀, is estimated. This removes the second-to-last column from (110). This could be useful if the clock bias is known from another source or if it is not needed. Indeed, errors in the clock bias and the initial in-track position will cancel out to first order when computing the spacecraft's inertial position.

Grouping in terms of orthogonal functions of time gives the system of equations

$$\begin{matrix}{d}_{1} α ( t ) = {c}_{n} {k}_{1} + {s}_{n} {k}_{2} + {k}_{3} \\ {d}_{2} α ( t ) = {c}_{n} {k}_{4} + {s}_{n} {k}_{5} + {ik}_{6} + {k}_{7} \\ {d}_{3} α ( t ) = {c}_{n} {k}_{8} + {s}_{n} {k}_{9}\end{matrix} \\ \begin{matrix}{k}_{1} = 3 {r}_{1} + \frac{2}{n} {v}_{2} \\ {k}_{2} = \frac{- 1}{n} {v}_{1} \\ {k}_{3} = - 4 {r}_{1} - \frac{2}{n} {v}_{2} \\ {k}_{4} = \frac{- 2}{n} {v}_{1} \\ {k}_{5} = - 6 {r}_{1} - \frac{4}{n} {v}_{2} \\ {k}_{6} = 6 {nr}_{1} + {3}_{v 2} - {na}_{0} {t}_{0} \\ {k}_{7} = - {r}_{2} + \frac{2}{n} {v}_{1} \\ {k}_{8} = - {r}_{3} \\ {k}_{9} = \frac{- 1}{n} {v}_{3}\end{matrix} \qquad ( 111 )$$

where x=[r₁ r₂ r₃ v₁ v₂ v₃ \dot{τ}₀]^{T}. Now, each of the equations for d₁α(t), d₂α(t), and d₃α(t) in (111) can be satisfied either when dⱼ=0 or when α(t) is the right-hand side divided by the corresponding dⱼ. This leaves five possible cases to check: (1) d1≠0, d2≠0, d3≠0; (2) d1≠0, d2≠0, d3≠0; (3) d1≠0, d2≠0, d3≠0; (4) d1≠0, d2≠0, d3≠0; and (5) d1≠0, d2≠0, d3≠0. For case (1), in this case, there are seven unknowns and six equations, so therefore, it is unobservable. For case (2), there are seven unknowns and six equations, so therefore, it is unobservable. For case (3), d2=0, therefore k₄=k₅=k₆=k₇=0. k₄=0 implies v₁=0, then combining that with k₇=0 implies r₂=0. From k₅=0,

$$0 = - 6 {r}_{1} - \frac{4}{n} {v}_{2} \qquad ( 112 )$$

$${v}_{2} = - n \frac{3}{2} {r}_{1} \qquad ( 113 )$$

From d₁α=d₃α, which implies k₃=0,

$$0 = - 4 {r}_{1} - \frac{2}{n} {v}_{2} \qquad ( 114 )$$

$${v}_{2} = - 2 {nr}_{1} \qquad ( 115 )$$

substituting

$$- n \frac{3}{2} {r}_{1} = - 2 {nr}_{1} \qquad ( 116 )$$

$$\frac{1}{2} {r}_{1} = 0. \qquad ( 117 )$$

which implies r₁=0 and v₂=0. Then, using that with k₆=0 gives

0=6nr₁+3v₂−na₀\dot{τ}₀ (118)

0=−na₀\dot{τ}₀ (119)

which implies to \dot{τ}₀=0. Then, for the out-of-plane terms,

$$\frac{- 1}{n} {v}_{3} = \frac{- 1}{n} {v}_{1} \qquad ( 120 )$$

$$- {r}_{3} = \frac{- 2}{n} {v}_{1} \qquad ( 121 )$$

which implies r₃=0 and v₃=0. Therefore, Ψx=0 iff x=0, so the case is observable. This assumes finite nonzero values for n, d, and a0.

For case (4), as in the previous case, d₂=0 implies v₁=r₂=0, 0=3v₂+6nr₁−na₀\dot{τ}₀, and

$${v}_{2} = - n \frac{3}{2} {r}_{1} .$$

Then, from the first and third equations, k₃=0, which implies v₂=−2nr₁. Combining the two expressions for v₂ implies r₁=v₂=0. Substituting that into the earlier equation for \dot{τ}₀ implies \dot{τ}₀=0. Using the harmonic components of d₁ and d₃ leads to the expressions d₃v₁=d₁v₃ and

$$- {d}_{1} {r}_{3} = {d}_{3} ( 3 {r}_{1} + \frac{2}{n} {v}_{2} ) ,$$

which imply r₃=v₃=0. Therefore, Ψx=0 iff x=0, so the case is observable.

For case (5), since there is no constant or linear term in the equation for d₃α(t) in (44), the constant and linear terms in the other equations are zero, thus

$$\begin{matrix}{k}_{3} = 0 \\ 0 = - 4 {r}_{1} - \frac{2}{n} {v}_{2} \\ {v}_{2} = - 2 {nr}_{1} \\ {k}_{7} = 0 \\ 0 = - {r}_{2} + \frac{2}{n} {v}_{1} \\ {v}_{1} = \frac{n}{2} {r}_{2} \\ 0 = {k}_{6} \\ = 6 {nr}_{1} + 3 {v}_{2} - {na}_{0} {\dot{τ}}_{0} \\ = 6 {nr}_{1} - 3 ( 2 {nr}_{1} ) - {na}_{0} {\dot{τ}}_{0} \\ = {\dot{τ}}_{0}\end{matrix} \qquad ( 122 )$$

Second, the harmonic terms from each pair of equations are equated.

$$\begin{matrix}{d}_{1} {k}_{4} = {d}_{2} {k}_{1} \\ {d}_{1} ( \frac{- 2}{n} {v}_{1} ) = {d}_{2} ( 3 {r}_{1} + \frac{2}{n} {v}_{2} ) \\ = {d}_{2} ( 3 {r}_{1} + \frac{2}{n} ( - 2 {nr}_{1} ) ) \\ = {d}_{2} ( - {r}_{1} ) \\ {v}_{1} = \frac{{d}_{2}}{{d}_{1}} \frac{n}{2} {r}_{1}\end{matrix} \\ \begin{matrix}{d}_{1} {k}_{5} = {d}_{2} {k}_{2} \\ {d}_{1} ( - 6 {r}_{1} - \frac{4}{n} {v}_{2} ) = {d}_{2} ( \frac{- 1}{n} {v}_{1} ) \\ {d}_{1} ( - 6 {r}_{1} - \frac{4}{n} ( - 2 {nr}_{1} ) ) = {d}_{2} ( \frac{- 1}{n} ( \frac{{d}_{2}}{{d}_{1}} \frac{n}{2} {r}_{1} ) ) \\ {d}_{1} ( 2 {r}_{1} ) = - \frac{1}{2} \frac{{d}_{2}^{2}}{{d}_{1}} {r}_{1} \\ 0 = \frac{{d}_{2}^{2} + 4 {d}_{1}^{2}}{{d}_{1}^{2}} {r}_{1} \\ 0 = {r}_{1}\end{matrix} \qquad ( 123 )$$

From there, it can be shown r₂=v₁=v₂=0 and then r₃=v₃=0. Therefore, Ψx=0 iff x=0, so the case is observable.

Landmarks fixed to a rotating central body, Earth, will now be examined. First, assume a simplified ERA model

θ(t)=θ₀+(ω_{⊕}+ω)t (124)

where ω_{⊕} is the angular velocity of the Earth and ω is a small adjustment, roughly equivalent to the length of day (LOD) EOP. The θ₀ and ω are additional states that can be estimated. The transformation between the Earth fixed, inertial, and Hill frames are

r^{H}=R_{I→H}r^{I}−aî

r_{I}=R_{E→I}r^{E} (125)

with

R_{I→H}=R\hat{k}(nt) (126)

R_{E→I}=Rî(i)R_{\hat{k}}(Ω)R_{\hat{k}}(−θ) (126)

where R_{â}(b) is a frame rotation constructed from the given axis and angle, i is inclination, Ω is right ascension of the ascending node, and θ is true anomaly.

As before, it is assumed the direction \hat{d} is measured in the inertial frame, e.g., using a star tracker to compute the camera's attitude. The sensitivity with respect to time is

$${d}^{l} = {r}_{g}^{l} - {r}_{s}^{l} \qquad ( 127 )$$

$$\frac{\partial {d}^{l}}{\partial t} = \frac{\partial {r}_{g}^{l}}{\partial t} - \frac{\partial {r}_{s}^{l}}{\partial t} \qquad ( 128 )$$

For the landmark, the derivative with time is taken as

$${r}_{g}^{l} = {R}_{E \to l} {r}_{g}^{E} \qquad ( 129 )$$

$$\frac{\partial {r}_{g}^{l}}{\partial t} = - {ω}_{⊕} {R}_{\hat{i}} ( i ) {R}_{\hat{k}} ( Ω ) {{R}_{\hat{k}} ( - θ ) [ \hat{k} ]}_{\times } {r}_{g}^{E} \qquad ( 130 )$$

$$= - {ω}_{⊕} {{R}_{E \to l} [ \hat{k} ]}_{\times } {r}_{g}^{E} \qquad ( 131 )$$

where the position of the landmark in the fixed frame, r_{g}^{E}, is assumed constant and [\hat{k}]ₓ is the cross product matrix.

Now, with the sensitivities computed, they are converted to a frame and a form conducive to further analysis using the nominal trajectory. Using the fact that along the nominal trajectory, r_{q}^{H}=d, the derivative may be restated as

$$\frac{\partial {r}_{g}^{l}}{\partial t} = - {ω}_{⊕} {{R}_{E \to l} [ \hat{k} ]}_{\times } {R}_{H \to E} ( d + {a}_{0} \hat{i} ) \qquad ( 132 )$$

$$= - {ω}_{⊕} {{R}_{\hat{i}} ( i ) [ \hat{k} ]}_{\times } {R}_{\hat{i}} ( - i ) {R}_{\hat{k}} ( - nt ) ( d + {a}_{0} \hat{i} ) \qquad ( 133 )$$

where the simplifications are possible because cross products and rotations about the same axis commute. Specifically, R_{\hat{k}}(−θ) [\hat{k}]ₓR_{\hat{k}}(θ)=R_{\hat{k}}(−θ)R_{\hat{k}}(θ) [\hat{k}]ₓ=[\hat{k}]ₓ. Then, the while derivative is transformed to the Hill frame,

$$\begin{matrix}{( \frac{\partial {d}^{l}}{\partial t} )}^{H} = {R}_{l \to H} ( \frac{\partial {r}_{g}^{l}}{\partial t} - \frac{\partial {r}_{s}^{l}}{\partial t} ) \\ = {R}_{l \to H} ( - {ω}_{⊕} {{R}_{\hat{i}} ( i ) [ \hat{k} ]}_{\times } {R}_{\hat{i}} ( - i ) {R}_{\hat{k}} ( - nt ) ( d + {a}_{0} \hat{i} ) + {na}_{0} {R}_{\hat{k}} ( - nt ) \hat{j} \\ = - {ω}_{⊕} {R}_{\hat{k}} ( nt ) {{R}_{\hat{i}} ( i ) [ \hat{k} ]}_{\times } {R}_{i} ( - i ) {R}_{\hat{k}} ( - nt ) ( d + {a}_{0} \hat{i} ) + {na}_{0} \hat{j} \\ = {ω}_{⊕} e + {na}_{0} \hat{j}\end{matrix} \qquad ( 134 )$$

where e is

$$e = [ \begin{matrix}0 & - {c}_{i} & {c}_{n} {s}_{i} \\ {c}_{i} & 0 & - {s}_{n} {s}_{i} \\ - {c}_{n} {s}_{i} & {s}_{n} {s}_{i} & 0\end{matrix} ] ( d + {a}_{0} \hat{i} ) = [ \begin{matrix}- {c}_{i} {d}_{2} + {c}_{n} {s}_{i} {d}_{3} \\ {c}_{i} ( {d}_{1} + {a}_{0} ) - {s}_{n} {s}_{i} {d}_{3} \\ - {c}_{n} {s}_{i} ( {d}_{1} + {a}_{0} ) + {s}_{n} {s}_{i} {d}_{2}\end{matrix} ] \qquad ( 135 )$$

Thus,

$$\begin{matrix}{Φ}_{r} ( t ) = [ \begin{matrix}4 - 3 {c}_{n} & 0 & 0 & \frac{1}{n} {s}_{n} & \frac{2}{n} ( 1 - {c}_{n} ) & 0 & & & & \\ 6 ( {s}_{n} - nt ) & 1 & 0 & \frac{2}{n} ( {c}_{n} - 1 ) & \frac{4}{n} {s}_{n} - 3 t & 0 & e & te & {na}_{0} + {ω}_{⊕} e & t ( {na}_{0} + {ω}_{⊕} e ) \\ 0 & 0 & {c}_{n} & 0 & 0 & \frac{- 1}{n} {s}_{n} & & & & \end{matrix} ] \\ x = {[ \begin{matrix}{r}_{1} & {r}_{2} & {r}_{3} & {v}_{1} & {v}_{2} & {v}_{3} & {θ}_{0} & ω & {τ}_{0} & {\dot{τ}}_{0}\end{matrix} ]}^{T}\end{matrix} \qquad ( 136 )$$

From this, it can be seen that the column for τ₀ is a linear combination of the columns for r₂ and θ₀, which renders τ₀ inseparable from the other two. Further analysis assumes TO is known by other means or is arbitrarily fixed. Then, splitting into orthogonal functions gives

$$α ( t ) d = [ \begin{matrix}- 3 {r}_{1} - \frac{2}{n} {v}_{2} + {s}_{i} {d}_{3} {θ}_{0} \\ \frac{2}{n} {v}_{1} \\ {r}_{3} - {s}_{i} ( {d}_{1} + {a}_{0} ) {θ}_{0}\end{matrix} ] {c}_{n} + [ \begin{matrix}\frac{1}{n} {v}_{1} \\ 6 {r}_{1} + \frac{4}{n} {v}_{2} - {s}_{i} {d}_{3} {θ}_{0} \\ \frac{- 1}{n} {v}_{3} + {s}_{i} {d}_{2} {θ}_{0}\end{matrix} ] {s}_{n} + \qquad ( 137 )$$

$$[ \begin{matrix}{s}_{i} {d}_{3} ( ω + {ω}_{⊕} {\dot{τ}}_{0} ) \\ 0 \\ - {s}_{i} ( {d}_{1} + {a}_{0} ) ( ω + {ω}_{⊕} {\dot{τ}}_{0} )\end{matrix} ] {ic}_{n} + [ \begin{matrix}0 \\ - {s}_{i} {d}_{3} ( ω + {ω}_{⊕} {\dot{τ}}_{0} ) \\ {s}_{i} {d}_{2} ( ω + {ω}_{⊕} {\dot{τ}}_{0} )\end{matrix} ] {is}_{n} +$$

$$[ \begin{matrix}- {c}_{i} {d}_{2} ( ω + {ω}_{⊕} {\dot{τ}}_{0} ) \\ - 6 {nr}_{1} - 3 {v}_{2} + {na}_{0} {\dot{τ}}_{0} + {c}_{i} ( {d}_{i} + {a}_{0} ) ( ω + {ω}_{⊕} {\dot{τ}}_{0} ) \\ 0\end{matrix} ] i +$$

$$[ \begin{matrix}4 {r}_{1} + \frac{2}{n} {v}_{2} - {c}_{i} {d}_{2} {θ}_{0} \\ {r}_{2} - \frac{2}{n} {v}_{1} + {c}_{i} ( {d}_{1} + {a}_{0} ) {θ}_{0} \\ 0\end{matrix} ]$$

The most difficult part will be separating \dot{τ}₀ from ω, since they only differ in their linear effect in the in-track direction. Since the landmark is on Earth, this leaves four cases to examine: (1) d₁≠0, d₂=0, d₃=0; (2) d₁≠0, d₂≠0, d₃=0; (3) d₁≠0, d₂=0, d₃≠0; and (4) d₁≠0, d₂≠0, d₃≠0.

For case (1), if sᵢ=0, then there are seven equations for nine unknowns and the system is unobservable. If sᵢ≠0, then (ω+ω_{⊕}\dot{τ}₀)=0 and there are seven equations for the remaining eight unknowns, and the system is unobservable. If sᵢ≠0 and ω is not estimated, i.e., assumed to be zero, then \dot{τ}₀=0, and the system reduces to that of only estimating r₁ through θ₀, which is shown to be unobservable in this case.

For case (2), if sᵢ=0, then there are six equations for nine unknowns and the system is unobservable. If sᵢ≠0, then (ω+ω_{⊕}\dot{τ}₀)=0, and there are six equations for the remaining eight unknowns and the system is unobservable. If sᵢ≠0, and ω is not estimated, then \dot{τ}₀=0, and the system reduces to that of only estimating r₁ through θ₀, which is shown to be unobservable in this case.

For case (3), substituting d₂=0 gives

$$α ( t ) d = [ \begin{matrix}- 3 {r}_{1} - \frac{2}{n} {v}_{2} + {s}_{i} {d}_{3} {θ}_{0} \\ \frac{2}{n} {v}_{1} \\ {r}_{3} - {s}_{i} ( {d}_{1} + {a}_{0} ) {θ}_{0}\end{matrix} ] {c}_{n} + [ \begin{matrix}\frac{1}{n} {v}_{1} \\ 6 {r}_{1} + \frac{4}{n} {v}_{2} - {s}_{i} {d}_{3} {θ}_{0} \\ \frac{- 1}{n} {v}_{3}\end{matrix} ] {s}_{n} + \qquad ( 138 )$$

$$[ \begin{matrix}{s}_{i} {d}_{3} ( ω + {ω}_{⊕} {\dot{τ}}_{0} \\ 0 \\ - {s}_{i} ( {d}_{1} + {a}_{0} ) ( ω + {ω}_{⊕} {\dot{τ}}_{0} )\end{matrix} ] {ic}_{n} + [ \begin{matrix}0 \\ - {s}_{i} {d}_{3} ( ω + {ω}_{⊕} {\dot{τ}}_{0} ) \\ 0\end{matrix} ] {is}_{n} +$$

$$[ \begin{matrix}0 \\ - 6 {nr}_{1} - 3 {v}_{2} + {na}_{0} {\dot{τ}}_{0} + {c}_{i} ( {d}_{1} + {a}_{0} ) ( ω + {ω}_{⊕} {\dot{τ}}_{0} ) \\ 0\end{matrix} ] t +$$

$$[ \begin{matrix}4 {r}_{1} + \frac{2}{n} {v}_{2} \\ {r}_{2} - \frac{2}{n} {v}_{1} + {c}_{i} ( {d}_{i} + {d}_{0} ) {θ}_{0} \\ 0\end{matrix} ]$$

If sᵢ=0, then there are eight equations for nine unknowns and the system is unobservable. If sᵢ≠0, then the tsₙ term implies (ω+ω_{⊕}\dot{τ}₀)=0, which, when substituted, gives the system

$$α ( t ) d = [ \begin{matrix}- 3 {r}_{1} - \frac{2}{n} {v}_{2} + {s}_{i} {d}_{3} {θ}_{0} \\ \frac{2}{n} {v}_{1} \\ {r}_{3} - {s}_{i} ( {d}_{1} + {a}_{0} ) {θ}_{0}\end{matrix} ] {c}_{n} + [ \begin{matrix}\frac{1}{n} {v}_{1} \\ 6 {r}_{1} + \frac{4}{n} {v}_{2} - {s}_{i} {d}_{3} {θ}_{0} \\ \frac{- 1}{n} {v}_{3}\end{matrix} ] {s}_{n} + \qquad ( 139 )$$

$$[ \begin{matrix}0 \\ - 6 {nr}_{1} - 3 {v}_{2} + {na}_{0} {\dot{τ}}_{0} \\ 0\end{matrix} ] t + [ \begin{matrix}4 {r}_{1} + \frac{2}{n} {v}_{2} \\ {r}_{2} - \frac{2}{n} {v}_{1} + {c}_{i} ( {d}_{1} + {a}_{0} ) {θ}_{0} \\ 0\end{matrix} ]$$

which has seven equations for the remaining eight unknowns, hence the system is unobservable. If sᵢ≠0 and ω is not estimated, then \dot{τ}₀=0, and the system reduces to that of only estimating r1 through θ₀, which is shown to be unobservable in this case.

For case (4), if sᵢ=0, then there are eight equations for nine unknowns and the system is unobservable. If sᵢ≠0, then (ω+ω_{⊕}\dot{τ}₀)=0, there are seven equations for the remaining eight unknowns, and the system is unobservable. If ω is not estimated, then the tcₙ term gives the condition

sᵢ\dot{r}₀=0 (140)

and the radial component of the t term gives the condition

cᵢ\dot{τ}₀=0 (141)

Since cᵢ=sᵢ=0 is a contradiction, therefore \dot{τ}₀=0. The system then reduces to the same case, which is observable iff

$$i \neq \frac{π}{2} .$$

In summary, τ₀ and ω are unobservable in all four cases. In the fourth case, when the observatory looks off nadir in both the in-track and cross-track directions and the orbit is not precisely polar, then the remaining states are observable (r₁ through v₃, θ₀, and \dot{τ}₀). Different combinations of states are possible as well. For example, since θ₀ is linearly dependent on τ₀, τ₀ may be estimated instead of θ₀, thus the spacecraft's clock errors can be estimated if the orientation of Earth is known. Conversely, ω may be estimated instead of \dot{τ}₀, so Earth's orientation may be estimated if the spacecraft's clock is known. In any case, it is a time scale based on Earth's rotation, e.g., Universal Time 1 (UT1), that is actually estimated.

### 7. EXEMPLARY METHODS

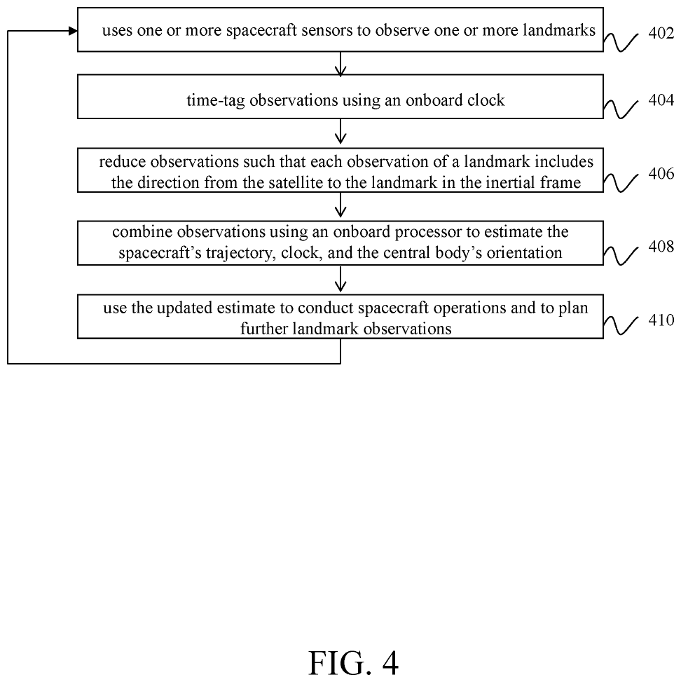

FIG. 4 is a flowchart of an exemplary method for determining spacecraft state and Earth orientation from landmark measurements in accordance with an embodiment of the present disclosure. In step 402, a spacecraft (e.g., navigational device 102) uses one or more sensors (e.g., sensor 104) to observe one or more landmarks. The sensors may use visible, radio, or other phenomena to remotely sense the landmark. In an embodiment, a landmark is any feature that can be distinguished by the spacecraft sensor. For example, a landmark could be a mountain peak, an asteroid, or another satellite. The trajectory of the landmark may be known a priori, or not. The landmark may be moving or stationary. In step 404, the observations are time-tagged by the spacecraft's onboard clock (e.g., clock 106). In step 406, the observations are reduced such that each observation of a landmark includes the direction from the satellite to the landmark in the inertial frame. This can be accomplished, for example, by use a machine learning model to locate a mountain peak in an image and a star tracker to determine the spacecraft's orientation in the inertial frame. Optionally autonomous measurements of range to the landmark may be included (e.g., RADAR or LIDAR). In step 408, the observations can be combined to estimate the spacecraft's trajectory, clock, and the central body's orientation (e.g., using controller 108 and/or processor 110). In an embodiment, this step can be performed using weighted lease squares or an extended Kalman filter. In step 410, the spacecraft uses the updated estimate to conduct its operations and to plan further landmarks observations. In an embodiment, this process can repeat and can return to step 402.

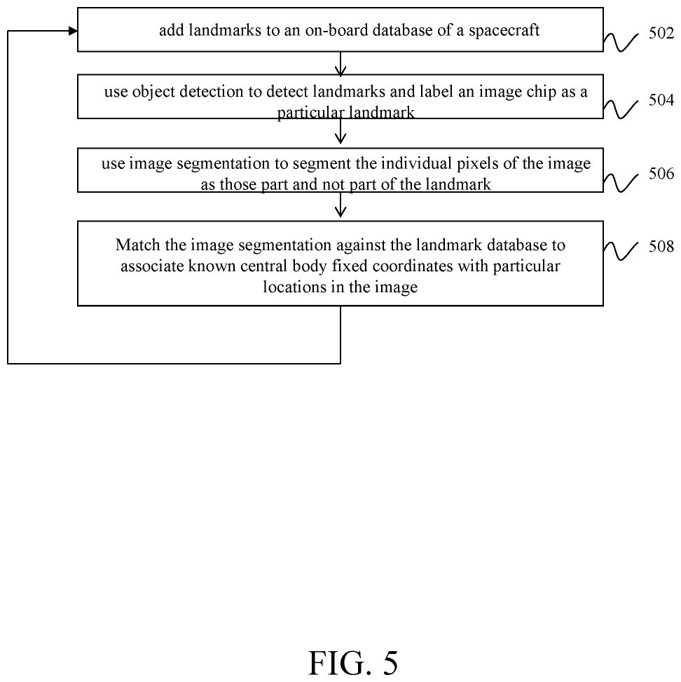

FIG. 5 is a flowchart of an exemplary method for detecting landmarks in satellite images using image segmentation in accordance with an embodiment of the present disclosure. In an embodiment, the method of FIG. 5 can be used as a possible implementation of step 406 in FIG. 4. In step 502, landmarks are added to a on-board database (e.g., stored in memory 112). In an embodiment, landmarks are described by their geometric shape (points, lines, polygons, etc.) and their coordinates in the central body fixed reference frame (e.g., roads, rives, coastlines, etc.) In step 504, an object detection system or method, such as a convolutional neural net (CNN), is used detect landmarks and label an image chip as a particular landmark. In step 506, an image segmentation system or method, such as a U-Net, is used to segment the individual pixels of the image as those part and not part of the landmark (e.g., road or not road). In step 508, the image segmentation is matched (e.g., through a series of affine transformations) against the landmark database to associate known central body fixed coordinates with particular locations in the image. In an embodiment, the association between image pixel locations and central body fixed coordinates can be used as input to step 408 in FIG. 4. In an embodiment, this process may be repeated, and the method can return to step 502 using the output of step 408 in FIG. 4 to add additional landmarks to the database autonomously.

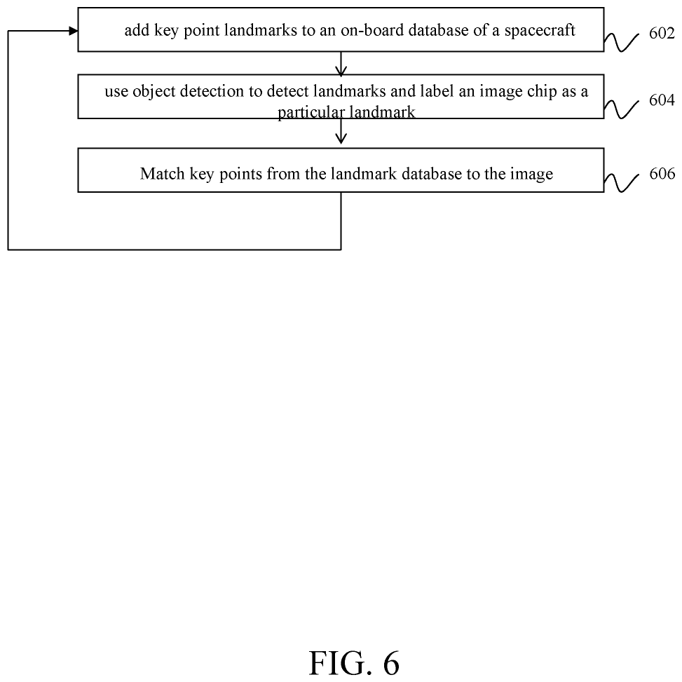

FIG. 6 is a flowchart of an exemplary method for detecting landmarks in satellite images using image segmentation in accordance with an embodiment of the present disclosure. In an embodiment, the method of FIG. 6 can be used as a possible implementation of step 408 in FIG. 4. In step 602, landmarks are added to an on-board database (e.g., database stored in memory 112). In an embodiment, landmarks are key points, that is, points easy for computer vision algorithms to recognize. In an embodiment, landmarks are described by a vector that the computer vision algorithm uses to identify key points, or an image chip of the landmark, as well as their coordinates in the central body fixed reference frame (e.g., mountain peaks, building corners, etc.) In step 604, optionally, an object detection algorithm, such as a convolutional neural net (CNN), is used detect landmarks and label an image chip as a particular landmark. In step 606, key points are matched from the landmark database to the image (e.g., using Scale Invariant Feature Transform (SIFT) or Speeded Up Robust Features (SURF)). In an embodiment, the association between image pixel locations and central body fixed coordinates can be used as an input to step 408 in FIG. 4. In an embodiment, this process may be repeated, and the method can return to step 602 using the output of step 408 in FIG. 4 to add additional landmarks to the database autonomously.

### 8. EXEMPLARY SPACECRAFT

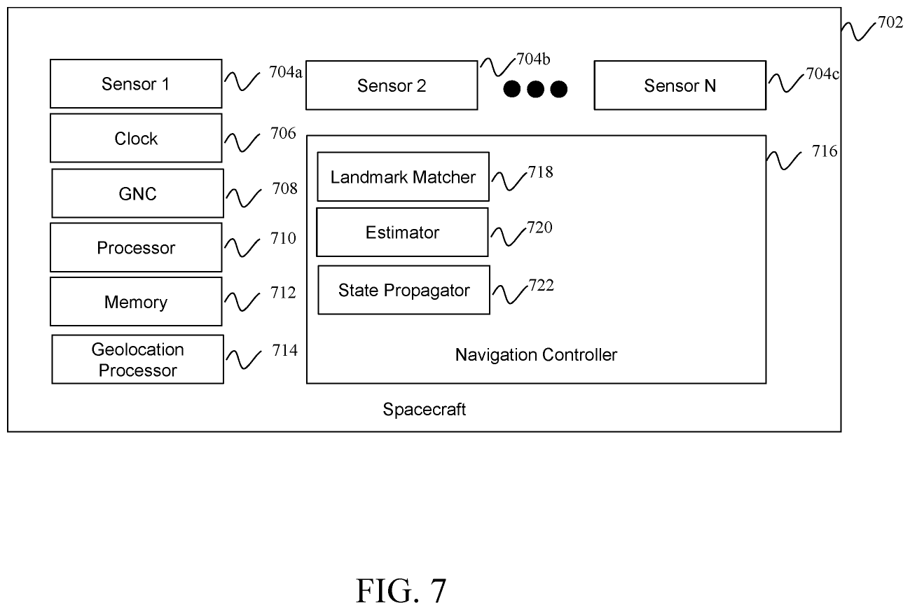

FIG. 7 is a block diagram of an exemplary spacecraft device in accordance with an embodiment of the present disclosure. The spacecraft 702 of FIG. 7 includes one or more sensors 704. For example, in an embodiment, sensor 1 704a is a camera, sensor 2 704b is a radio frequency (RF) sensor, and sensor N 704c is an antenna. Sensors 704 can include a variety of other sensors, including monopulse sensors to measure an angle of arrival, X-Ray, and/or ultraviolet (UV) sensors. The spacecraft 702 of FIG. 7 also includes a clock 706, a guidance, navigation, and control module (GNC) 708, a processor 710, a memory 712 (e.g., in an embodiment, used to store a database including celestial body models and/or images), and a geolocation processor 714. In an embodiment, GNC 708 instructs spacecraft 702 to execute maneuvers, such as station keeping maneuvers and/or collision avoidance maneuvers based on information from navigation controller 716. In an embodiment, GNC 708 is a GPS module.

The spacecraft of FIG. 7 also includes a navigation controller 716. The navigation controller 716 of FIG. 7 includes a landmark matcher 718, estimator 720, and a state propagator 722. In an embodiment, geolocation processor 714 performs onboard processing, takes data from sensors 704, queries state propagator 722, and geolocates images. In an embodiment, landmark matcher 718 can function in two modes. In an embodiment, one mode takes in sensor data from sensors 704 and pairs a pixel in an image to a known landmark in a database stored in memory 712, and another mode can take two raw images from sensor data and pair a pixel to a landmark in both images.

In an embodiment, estimator 720 estimator uses output from landmark matcher 718 and computes a direction to that identified landmark. In an embodiment, since a landmark is associated to known landmark in a database, estimator 720 knows a location on earth and can compare the distance observed from landmark matcher 720 to a computed distance from a current best estimate from the state of spacecraft 702 (e.g., rom state propagator 722). In an embodiment, the angular distance between these two distances can be referred to as a residual distance, and estimator 720 can minimize the residual distance by producing a new estimate (e.g., using least squares or a Kalman filter).

In an embodiment, state propagator 722 allows for the use of time series of measurements relative to a state at some time in the past so that measurements can inform where spacecraft was at that epoch in the past. In an embodiment, state propagator 722 predicts states (e.g., satellite position, velocity) from one epoch (arbitrarily chosen date) to another (e.g., the current time) to give a full time history.

Landmark matcher 718, estimator 720, and state propagator 722 can be implemented using a single device (e.g., integrated into navigation controller 716 and/or spacecraft 702) or multiple devices (e.g., as separate special purpose devices) in accordance with embodiments of the present disclosure. In an embodiment, navigation controller 716 is configured to perform methods for determining spacecraft state and Earth orientation from landmark measurements (e.g., such as the methods described in the flowcharts of FIGS. 2-6) and is configured to instruct spacecraft 702 to perform operations based on the results of these methods. For example, in an embodiment, navigation controller can send and/or receive information from sensors 704, clock 706, GNC 708, processor 710, memory 712, and/or geolocation processor 714 to perform these methods and instruct spacecraft 702 how to navigate based on, for example, detected landmarks.

Embodiments of the present disclosure can be implemented using hardware, software, and/or a combination of hardware and software. Embodiments of the present disclosure can be implemented using one or more devices. In an embodiment, components of spacecraft 702 are implemented as a special purpose device. For example, in an embodiment, spacecraft 702 is a satellite, and components of spacecraft 702 are implemented as on-board components of spacecraft 702.

### 9. EXEMPLARY ADVANTAGES

Embodiments of the present disclosure provide autonomy from large ground station networks maintained by the International Earth Rotation Service (IERS), US Naval Observatory (USNO), and others to measure Earth's orientation in space. Previously these Earth Orientation Parameters (EOP) would need to be uplinked to the spacecraft as it was unable to estimate the EOP autonomously. Embodiments of the present disclosure enable a spacecraft to be able to determine EOP autonomously.

The measured EOP enabled by embodiments of the present disclosure may be useful science data. For example, a deep space mission to a comet could estimate some physical parameters of its central body autonomously. As mentioned earlier, autonomy provides opportunities for increased resiliency, reliability, and capability while using fewer ground resources (e.g., mission controllers, and antennas).

Embodiments of the present disclosure use computer vision/machine learning algorithms in parallel and train a convolutional neural network to find landmarks of interest and pass the result to an image segmentation model that can extract navigational information on a pixel-based level.

### 10. CONCLUSION

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Any representative signal processing functions described herein can be implemented using computer processors, computer logic, application specific integrated circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented using a computer program executing on a machine, using a computer program product, or using a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g., software) can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

What is claimed is:

1. A spacecraft configured to autonomously navigate independent of a ground station network, the spacecraft comprising:
a sensor configured to observe a landmark, thereby generating an observation; and
a controller configured to:
reduce the observation,
estimate a trajectory, clock, and central body orientation of the spacecraft using the reduced observation, and
plan an operation based on the estimated trajectory, clock, and central body orientation.

2. The spacecraft of claim 1, further comprising a clock, wherein the controller is further configured to time-tag the observation using the clock.

3. The spacecraft of claim 1, wherein the controller is further configured to reduce the observation such that the observation include a direction from the spacecraft to the landmark in an inertial frame.

4. The spacecraft of claim 3, wherein the controller is further configured to use a machine learning model to locate a mountain peak in an image in the observation and a star tracker to determine the orientation in the inertial frame.

5. The spacecraft of claim 1, wherein the controller is further configured to:
combine the observation with an additional observation, thereby generating a combined observation; and
estimate the trajectory, clock, and central body orientation of the spacecraft using the combined observation.

6. The spacecraft of claim 5, wherein the controller is further configured to:
combine the observation with an additional observation using a weighted lease squares method or an extended Kalman filter.

7. The spacecraft of claim 1, wherein the controller is further configured to reduce the observation by:
identifying a landmark in an image in the observation;
segmenting the image into a plurality of pixels;
using a location of the landmark for an estimation; and
using the estimation to add an additional landmark.

8. The spacecraft of claim 7, wherein the controller is further configured to:
identify the landmark by labeling an image chip in the image as the landmark.

9. The spacecraft of claim 8, wherein the controller is further configured to:
identify key points in the image chip; and
match the identified key points with key points corresponding to a known landmark in a landmark database.

10. The spacecraft of claim 1, wherein the controller is further configured to:
use image segmentation to segment pixels of the image as pixels part of the landmark and pixels not part of the landmark, thereby generating a segmented image.

11. The spacecraft of claim 10, wherein the controller is further configured to:
match the segmented image against a landmark database to associate known central body fixed coordinates with particular locations in the segmented image.

12. A method for autonomously navigating a spacecraft independent of a ground station network, the method comprising:
observing a landmark using a sensor, thereby generating an observation;
reducing the observation;
estimating a trajectory, clock, and central body orientation of the spacecraft using the reduced observation; and
planning an operation for the spacecraft based on the estimated trajectory, clock, and central body orientation.

13. The method of claim 12, wherein reducing the observation further comprises:
reducing the observation such that the observation include a direction from the spacecraft to the landmark in an inertial frame.

14. The method of claim 12, further comprising:
combining the observation with an additional observation, thereby generating a combined observation; and
estimating the trajectory, clock, and central body orientation of the spacecraft using the combined observation.

15. The method of claim 12, further comprising:
identifying a landmark in an image in the observation;
segmenting the image into a plurality of pixels;
using a location of the landmark for an estimation; and
using the estimation to add an additional landmark.

16. The method of claim 15, further comprising:
identifying the landmark by labeling an image chip in the image as the landmark.

17. The method of claim 16, further comprising:
identifying key points in the image chip; and
matching the identified key points with key points corresponding to a known landmark in a landmark database.

18. The method of claim 12, further comprising:
using image segmentation to segment pixels of the image as pixels part of the landmark and pixels not part of the landmark, thereby generating a segmented image.

19. The method of claim 18, further comprising:
matching the segmented image against a landmark database to associate known central body fixed coordinates with particular locations in the segmented image.

20. A navigational device configured to autonomously navigate independent of a ground station network, the navigational device comprising:
a sensor configured to observe a landmark, thereby generating an observation; and
a controller configured to:
reduce the observation,
estimate a trajectory, clock, and central body orientation of the spacecraft using the reduced observation, and
plan an operation based on the estimated trajectory, clock, and central body orientation.
